(19) United States
(12) Patent Application Publication
(10) Pub. No.: US 2022/0190894 A1
(43) Pub. Date: Jun. 16, 2022

(54) MODULATION APPARATUS AND DEMODULATION APPARATUS

(71) Applicant: NEC Corporation, Minato-ku, Tokyo (JP)

(72) Inventors: Norifumi KAMIYA, Tokyo (JP); Mamoru SAWAHASHI, Tokyo (JP)

(73) Assignee: NEC Corporation, Minato-ku, Tokyo (JP)

(21) Appl. No.: 17/605,088

(22) PCT Filed: Apr. 6, 2020
(86) PCT No.: PCT/JP2020/015458

§ 371 Date: Oct. 20, 2021

(30) Foreign Application Priority Data
Apr. 25, 2019 (JP) 2019-083947

(51) Int. Cl. H04B 7/0456; H04J 13/22; H04L 27/26

(52) U.S. Cl. CPC H04B 7/0478; H04L 27/26; H04J 13/22

(57) ABSTRACT

A modulation apparatus capable of performing highly efficient multiplexing of pilot signals used for equalization and estimation of phase noises for LOS-MIMO (Line Of Sight-Multiple Input Multiple Output) using a single-carrier signal is provided. The modulation apparatus (10) includes means (11) for transforming a time-domain pilot signal sequence into a first number of frequency-domain signals corresponding to a sequence length of the pilot signal sequence, means (12) for mapping the first number of frequency-domain signals at the same number of subcarrier intervals as a number of transmitting antennas of the modulation apparatus by shifting mapping positions of heads of the frequency-domain signals one after another by an amount equivalent to one subcarrier so that the frequency-domain signals do not overlap each other, and means (13) for transforming the mapped frequency-domain signals into time-domain signals.

### TECHNICAL FIELD

The present disclosure relates to a modulation apparatus and a demodulation apparatus, and in particular to a modulation apparatus and a demodulation apparatus in a MIMO (Multiple Input Multiple Output) radio communication system in a line-of-sight (LOS: Line-of-Sight) environment.

### BACKGROUND ART

As communication apparatuses in conformity with LTE (Long Term Evolution) scheme and LTE-Advanced scheme have rapidly become widespread, it has become possible to provide full-fledged mobile broadband services. In the fifth generation (5G) mobile communication scheme, in order to cope with a rapid increase in traffic in a cellular network, it is necessary to increase the speed and the capacity as well as the efficiency of use of frequencies even further as compared to those in the LTE. The 5G mobile communication scheme requires a highly efficient radio access technology in addition to a heterogeneous network in which small cells that efficiently accommodate heterogeneous traffic in macro-cells are overlaid on each other.

Further, in addition to the ultra-high-speed and high-capacity radio access network in which gigabit-level services are provided to user equipment (UE), it is necessary to increase the speed and the capacity of back-haul between a base station and an S-GW (Serving-Gateway) of an EPC (Evolved Packet Core) network even further. The back-haul link is composed of an E1 private line, a T1 private line, an optical-fiber network, micro-wave wireless back-haul, and so on. The wireless back-haul has an advantage that the network cost thereof can be reduced as compared to that of wired back-haul. The above also applies to front-haul that connects, in a configuration in which processes in the physical layer of the baseband and higher layers thereof are performed in a base station formed by remote radio equipment (RRE: Remote Radio Equipment) and a centralized base station, the RRE to the centralized base station.

In wireless back-haul using micro-waves, the efficiency of use of frequencies has been improved by increasing the number of levels of modulation in a signal-space arrangement, by using polarization MIMO (Multiple Input Multiple Output) multiplexing using vertical and horizontal polarization, and by using line-of-sight (LOS: Line-of-Sight)-MIMO multiplexing (e.g., Patent Literature 1). In general, the MIMO multiplexing is a transmission scheme in which a plurality of antennas are provided in each of a transmitter and a receiver, and a plurality of transmission streams are spatially multiplexed by using a characteristic that variations in the propagation path, i.e., channel responses, between transmitting antennas and receiving antennas are different from one another.

In a line-of-sight (LOS) environment, since the correlation of the channel response between different transmitting antennas and receiving antennas is close to one, only one stream can be transmitted, so that it is impossible to spatially multiplexing a plurality of transmission streams. In this regard, it has been proposed that it is possible to orthogonally multiplex a plurality of transmission streams when a distance D between a transmitter and a receiver, and a distance d between antennas of each of the transmitter and the receiver (assuming that a distance between antennas of the transmitter is equal to that of antennas of the receiver) have a certain relationship therebetween (Non-patent Literature 1).

MIMO in a line-of-sight (LOS) environment is called LOS-MIMO to distinguish it from MIMO multiplexing in a non-line-of-sight (NLOS: Non-Line-of-Sight) environment in which channel responses between antennas of the transmitter and those of the receiver are different from one anther (e.g., Patent Literature 2). FIG. 1 shows an example of a LOS-MIMO system in which each of a transmitter and a receiver includes two antennas. LOS-MIMO in which each of a transmitter and a receiver includes two antennas will be expressed as 2×2 LOS-MIMO. FIG. 1 shows an example of a configuration of a 2×2 LOS-MIMO system. As shown in FIG. 1, a LOS-MIMO radio communication system 1000 includes a transmitter (transmitting apparatus) 500 and a receiver (receiving apparatus) 600. The transmitter 500 includes two transmitting antennas (Tx #0 and Tx #1), and the receiver 600 also includes two receiving antennas (Rx #0 and Rx #1).

In a 2×2 LOS-MIMO system, a channel matrix between the transmitting antennas provided in the transmitter 500 and those provided in the receiver 600 can be expressed by the below-shown Expression (1) (Non-patent Literatures 1 and 2).

$$\begin{matrix}[ Expression 1 ] & \\ H = [ \begin{matrix}1 & {e}^{- j θ} \\ {e}^{- j θ} & 1\end{matrix} ] & ( 1 )\end{matrix}$$

In the Expression (1), rows represent receiving-antenna indices and columns represent transmitting-antenna indices. For example, in the case of the transmitting antenna Tx #0, the transmitting-antenna index is 0, and in the case of the receiving antenna Rx #0, the receiving-antenna index is 0. The same applies to the other transmitting and receiving antennas. θ in the Expression (1) is expressed by the below-shown expression by using a distance D between the transmitter 500 and the receiver 600, a distance d between the antennas of each of the transmitter and receiver, and a wavelength k (Non-patent Literature 1).

θ≅πd²/λD [Expression 2]

Therefore, an optimal antenna distance dₒₚₜ is expressed by the below-shown expression.

\sqrt{λD/2} (θ=π/2) [Expression 3].

Under this condition, it is possible to orthogonally multiplexing two transmission streams. Unlike the receiver in the NLOS-MIMO radio communication system, the receiver 600 does not require a signal separation process. However, the receiver 600 may receive, in addition to direct waves, delayed waves due to reflection of waves on the ground and the like. Multipath fading, i.e., frequency-selectivity fading, occurs due to the delayed waves. Therefore, the receiver 600 requires an equalizer.

When wireless back-haul is used, an equalizer that performs a time-domain process is typically used in the receiver 600. The time domain equalizer (TDE: Time Domain Equalizer) can be implemented by a Transversal filter or a FIR (Finite Impulse Response) filter. FIG. 2 shows an example of a configuration of a TDE using a transversal filter. In the case of a configuration of a TDE using a transversal filter, a transversal filter including a number of taps equivalent to or larger than the maximum delay time of delay waves is used for a discrete-time sample process. A weighting factor (equalization weight) of the transversal filter is updated for delay waves, which change over time, by using an adaptive algorithm. A minimum mean square error (MMSE: Minimum Mean Square Error) criterion for equalized signals is used to control the weighting factor. In The TDE, a certain number of taps for a sufficiently long time range as compared to the maximum delay time of delay waves (multiple paths) is required. As shown in FIG. 2, in the TDE, a convolution process including a certain number of complex multiplications corresponding to the number of taps needs to be performed for each sample value. Therefore, as the maximum delay time of delay waves increases, the number of taps increases and the amount of calculation for the convolution process enormously increases.

Therefore, a frequency domain equalizer (FDE: Frequency Domain Equalizer) has been proposed to reduce the amount of calculation performed in the time domain equalizer (Non-patent Literature 3). FIG. 3 shows an example of a configuration of the FDE. In the configuration of the FDE, a reception signal in a time domain is transformed into a signal in a frequency domain through a discrete Fourier transform (DFT: Discrete Fourier Transform) or a fast Fourier transform (FFT: Fast Fourier Transform). The number of samples in the time domain in an FFT corresponds to the number of subcarriers of the frequency-domain signal. In this specification, frequency components that are obtained by transforming a single carrier signal into a frequency-domain signal through an FFT are referred to as subcarriers. Each subcarrier component in the frequency domain is multiplied by an equalization weight (weighting factor). When a complex channel response in a subcarrier k is represented by hₖ, an equalization weight of a minimum mean square error (MMSE) criterion is expressed by the below-shown Expression (2) (Non-patent Literature 3).

$$\begin{matrix}[ Expression 4 ] & \\ {W}_{k} = \frac{{h}_{k}^{*}}{{\vert {h}_{k} \vert}^{2} + \frac{{σ}_{n}^{2}}{{σ}_{s}^{2}}} & ( 2 )\end{matrix}$$

Where * represents a complex conjugate; σ²ₙ represents power of a noise; and σ²ₛ, represents power of a desired wave signal.

The equalized signal is transformed into a time-domain signal through an inverse discrete Fourier transform (IDFT: Inverse Discrete Fourier Transform) or an inverse fast Fourier transform (IFFT: Inverse Fast Fourier Transform). Although the FDE requires the FFT (DFT) and the IFFT (IDFT), the overall amount of calculation can be reduced as compared to that in the configuration of the TDE because the equalization process for each subcarrier position can be performed by a multiplication process. Therefore, in the single-carrier FDMA (Frequency Division Multiple Access) of the uplink in the LTE, a wireless interface based on the use of an FDE is adopted.

As described above, the FDE requires a channel response at each subcarrier position in order to generate an equalization weight. For the estimation of a channel response, a pilot signal of which the transmission phase or the amplitude is known in the receiver is used. In the LTE, the pilot signal is called a reference signal (RS: Reference Signal). Further, in the LTE, reference signals of a plurality of user terminals that simultaneously access the same time slot in the uplink are code-division multiplexed (i.e., CDM: Code Division Multiplexing) by using cyclic shifts of which spread codes are different.

The principle of operations according to a CDM multiplexing method for pilot signals using cyclic shifts of which spread codes are different is explained with reference to FIG. 4. FIG. 4 is a diagram for explaining the principle of operations according to the CDM multiplexing method for pilot signals using cyclic shifts of which spread codes are different. The method shown in FIG. 4 is performed in the transmitter 500 shown in FIG. 1. The transmitter 500 includes a spread sequence generation unit 501 and a cyclic shift generation unit 502. For the spread codes, codes of which the auto-correlation is small when they are time-shifted, such as an M-sequence and a Zadoff-Chu sequence, are used (Non-patent Literature 4). In particular, in the case of the Zadoff-Chu sequence, it is possible to significantly reduce the auto-correlation when it is time-shifted, and thereby to reduce multi-path interference from multiple paths (delayed waves) to a low level.

The spread sequence generation unit 501 generates spread codes such as the Zadoff-Chu sequence. The cyclic shift generation unit 502 receives the spread codes and generates a cyclic shift sequence including different numbers of cyclic shifts corresponding to the number of users of which signals are multiplexed at the same time. When the length of the original spread code sequence is represented by N_{ZC} and the number of cyclic shifts is represented by N_{CS}, the length of the cyclic shift sequence (i.e., the amount of cyclic shifts) of the cyclic shift index is expressed as N_{ΔCS}=N_{ZC}/N_{CS}. It is necessary to increase the number of cyclic shifts as the number of user terminals that perform simultaneous access increases. As a result, the amount N_{ΔCS} of a shift between different cyclic shifts, i.e., the sequence length, decreases. The time of the sequence length N_{ΔCS} between different cyclic shifts needs to be made longer than the maximum delay time of the multiple paths. This is because if the delay time of the multiple paths is longer than the cyclic shift amount N_{ΔCS}, inter-symbol interference between codes using different cyclic shifts will occur. The spread code multiplexing using cyclic shifts can be applied to multiplexing of pilot signals of different transmitting antennas in LOS-MIMO. However, as the number of transmitting antennas increases, the cyclic shift amount N_{ΔCS} decreases. Therefore, in the case of a multi-path fading channel in which the delay times of multiple paths are long, inter-symbol interference occurs.

### CITATION LIST

### Patent Literature

Patent Literature 1: Japanese Unexamined Patent Application Publication No. 2004-080110
Patent Literature 2: International Patent Publication No. WO2016/111126

### Non Patent Literature

Non-patent Literature 1: P. F. Driessen and G. J. Foschini, “On the capacity formula for multiple input-multiple output wireless channels: A geometric interpretation,” IEEE Trans. Commun., vol. 47, no. 2, pp. 173-176, February 1999.
Non-patent Literature 2: I. Sarris and A. R. Nix, “Design and performance assessment of high-capacity MIMO architectures in the presence of a line-of-sight component,” IEEE Trans. Veh. Technol., vol. 56, no. 4, pp. 2194-2202, July 2007.
Non-patent Literature 3: D. Falconer, S. L. Ariyavisitakul, A. Benyamin-Seeyar, and B. Eidson, “Frequency domain equalization for single-carrier broadband wireless systems,” IEEE Commun. Mag., vol 40, no. 4, pp. 58-66, April 2002.
Non-patent Literature 4: D. C. Chu, “Polyphase codes with good periodic correlation properties,” IEEE Trans. Inform. Theory, vol. IT-18, pp. 531-532, July 1972.
Non-patent Literature 5: N. Kamiya and E. Sasaki, “Pilot-Symbol Assisted and Code-Aided Phase Error Estimation for High-Order QAM Transmission,” IEEE Trans. on Commun., vol. 61, no. 10, pp. 4369-4380, October 2013.
Non-patent Literature 6: D. Petrovic, W. Rave, and G. Fettweis, “Effects of phase noise on OFDM systems with and without PLL: characterization and compensation,” IEEE Trans. on Commun., vol. 55, no. 8, pp. 1607-1616, August 2007.
Non-patent Literature 7: S. Wu and Y. Bar-Ness, “A phase noise suppression algorithm for OFDM-based WLANs,” IEEE Commun. Lett., vol. 6, no. 12, pp. 535-537, December 2002.
Non-patent Literature 8: 3GPP TR 38.874 Study on Integrated Access and Backhaul, V16.0.0 (2018 December).

### SUMMARY OF INVENTION

### Technical Problem

Examples of the main causes for deterioration in characteristics of wireless back-haul include multi-path interference by delayed waves and phase noises caused by frequency fluctuations of a reference oscillator. In LOS-MIMO, an equalizer is essential in order to compensate for frequency-selectivity waveform distortions caused by multi-path interference. Further, it is necessary to estimate phase noises which change over time, and to compensate for phase variations caused by noises in reception signals. To generate an equalization weight for an equalizer and estimate phase noises, it is necessary to periodically multiplex, between data symbols, pilot signals of which transmission symbols (bits) are known in the receiver. As described above, the pilot signal is called a reference signal (RS) in the LTE. Further, in LOS-MIMO, orthogonal pilot signals unique to transmitting antennas are required. In the case of a single-carrier signal, an orthogonal pilot signal is generated in a time domain, a frequency domain, and a code (symbol) domain. Among the three types of multiplexing methods, the time division multiplexing (TDM: Time Division Multiplexing) in which a plurality of pilot signals unique to transmitting antennas are orthogonally-multiplexed in the time domain requires a number of symbol resources corresponding to the number of transmitting antennas. In order to reduce noise components of a channel response estimated for each antenna, a plurality of symbols are required. Further, the same number of symbol sets as the number of transmitting antennas are required. Therefore, as the number of transmitting antennas increases, a large number of pilot symbols are required. As the overhead of pilot signals increases, symbol resources that can be used for multiplexing of information symbols are reduced. Further, cyclic shift CDM multiplexing, which can significantly reduce the cross-correlation between codes, is a very effective multiplexing method when the number of necessary orthogonal pilot signals is small. However, when the number of transmitting antennas increases and hence the number of necessary orthogonal pilot symbols increases, the amount of a cyclic shift between different sequences becomes shorter. Therefore, as the delay times of multiple paths become longer than the cyclic shift amount, inter-symbol interference occurs.

The present disclosure has been made in view of the above-described circumstances, and one of the objects thereof is to provide a modulation apparatus and a demodulation apparatus capable of performing highly efficient multiplexing of pilot signals used for equalization and estimation of phase noises for LOS-MIMO using a single-carrier signal.

Further, in particular, when the delay times of multiple paths are long, an FDE, which can reduce the amount of calculation as compared to that of a TDE, is effective in the receiver. In the uplink of the LTE, a wireless interface based on the use of an FDE is adopted. As described above, in LOS-MIMO using micro-waves or millimeter waves, estimation of phase noises and compensation therefor are required. In LOS-MIMO, it is necessary to set the distance between antennas to a larger value, and thereby to prepare a reference oscillator for each antenna. Further, even in a receiver, independent estimation of phase noises and compensation therefor unique to each receiving antenna are required. Therefore, there is a demand for a method for estimating phase noises and compensating therefor suitable for an FDE in which error rate performance and the amount of calculation are taken into consideration.

The present disclosure has been made in view of the above-described circumstances, and another object thereof is to provide, for LOS-MIMO using a single carrier signal, a demodulation apparatus that estimates phase noises and compensates therefor suitable for an FDE.

### Solution to Problem

A modulation apparatus according to a first aspect of the present disclosure is a modulation apparatus used in a line of sight multiple input multiple output (LOS-MIMO: Line Of Sight-Multiple Input Multiple Output) radio communication system, including:

means for transforming a time-domain pilot signal sequence into a first number of frequency-domain signals corresponding to a sequence length of the pilot signal sequence;

means for mapping the first number of frequency-domain signals at the same number of intervals as a number of transmitting antennas of the modulation apparatus by shifting mapping positions of heads of the frequency-domain signals one after another by an amount equivalent to one subcarrier so that the frequency-domain signals do not overlap each other;

means for transforming the mapped frequency-domain signals into time-domain signals; and

means for setting the time-domain signals in a pilot block.

A modulation apparatus according to a second aspect of the present disclosure is a modulation apparatus used in a line of sight multiple input multiple output (LOS-MIMO: Line Of Sight-Multiple Input Multiple Output) radio communication system, including:

means for generating a spread code of a sequence length of a time-domain pilot signal sequence and generating a second number of cyclic shift sequences by cyclically shifting the generated spread code;

means for transforming the second number of pilot signals into a third number of frequency-domain signals corresponding to the sequence length;

means for mapping the third number of frequency-domain signals onto a fifth number of frequency components at a fourth number of intervals by shifting mapping positions of heads of the frequency-domain signals one after another by an amount equivalent to one subcarrier so that the frequency-domain signals do not overlap each other, the fourth number being a number based on the number of transmitting antennas of the modulation apparatus and the second number, and the fifth number being a number based on the sequence length and the fourth number;

means for transforming the mapped frequency-domain signals into time-domain signals; and

means for setting the time-domain signals in a pilot block.

A demodulation apparatus according to a third aspect of the present disclosure is a demodulation apparatus used in a line of sight multiple input multiple output (LOS-MIMO: Line Of Sight-Multiple Input Multiple Output) radio communication system, including:

means for transforming a pilot signal contained in a reception signal into a frequency-domain signal;

means for shifting a position of a first subcarrier from the frequency-domain signal, and extracting the same number of subcarrier signals as the number of receiving antennas of the demodulation apparatus at the same number of intervals as the number of receiving antennas thereof;

means for generating a channel response by multiplying each of the same number of subcarrier signals as the number of receiving antennas by a complex conjugate of a frequency-domain sequence of the pilot signal;

means for averaging, for each of the same number of subcarrier signals as the number of receiving antennas, channel responses of a plurality of subcarrier signals spaced apart from one another at the same number of subcarrier intervals as the number of receiving antennas; and

means for interpolating, based on the averaged channel response of each of the same number of subcarrier signals as the number of receiving antennas, a channel response of a signal in which each information symbol contained in the reception signal is set.

A demodulation apparatus according to a fourth aspect of the present disclosure is a demodulation apparatus used in a line of sight multiple input multiple output (LOS-MIMO: Line Of Sight-Multiple Input Multiple Output) radio communication system, including:

means for transforming a pilot signal contained in a reception signal into a frequency-domain signal;

means for shifting a position of a first subcarrier from the frequency-domain signal, and extracting a first number of subcarrier signals at the first number of intervals, the first number being a number based on the number of receiving antennas of the demodulation apparatus and the number of cyclic shifts of the pilot signal;

means for generating a channel response by multiplying each of the first number of extracted subcarrier signals by a complex conjugate of a frequency-domain sequence corresponding to the number of cyclic shifts, and adding, in an in-phase manner, a plurality of subcarrier signals spaced apart from one another at the first number of intervals;

means for averaging, for each of the same number of subcarrier signals as the number of receiving antennas, channel responses of a plurality of subcarrier signals spaced apart from one another at the same number of subcarrier intervals as the number of receiving antennas; and

means for interpolating, based on the averaged channel response of each of the same number of subcarrier signals as the number of receiving antennas, a channel response of a signal in which each information symbol contained in the reception signal is set.

A demodulation apparatus according to a fifth aspect of the present disclosure is a demodulation apparatus used in a line of sight multiple input multiple output (LOS-MIMO: Line Of Sight-Multiple Input Multiple Output) radio communication system, including:

means for estimating, by using a pilot signal contained in a reception signal, a first channel response of a transmission signal transmitted from each of a plurality of transmitting antennas provided in another radio communication apparatus;

means for estimating, based on the estimated first channel response, a phase variation at a pilot block position at which the pilot signal is set;

means for, based on the phase variation at the pilot block position, interpolating and compensating for the phase variation at a block position at which an information symbol included between adjacent pilot block positions is set;

means for transforming the reception signal which has been compensated for the phase variation into a frequency-domain signal;

means for estimating, by using the pilot signal contained in the frequency-domain signal, a second channel response indicating a channel response, at each of a plurality of subcarrier positions, to a transmission signal transmitted from each of the plurality of transmission antennas;

means for generating an equalization weight based on the estimated second channel response, and equalizing the frequency-domain signal by multiplying an information symbol at each of the plurality of subcarrier positions by the equalization weight; and

means for transforming the equalized frequency-domain signal into a time-domain signal.

A demodulation apparatus according to a sixth aspect of the present disclosure is a demodulation apparatus used in a line of sight multiple input multiple output (LOS-MIMO: Line Of Sight-Multiple Input Multiple Output) radio communication system, including:

means for transforming a time-domain reception signal into a frequency-domain signal;

means for estimating, by using a pilot signal contained in the transformed frequency-domain signal, a channel response, at each of a plurality of subcarrier positions, to a transmission signal transmitted from each of a plurality of transmission antennas provided in another radio communication apparatus;

means for estimating, based on the estimated channel response, a common phase variation common to all the subcarrier positions, and compensating for the estimated common phase variation from the transformed frequency-domain signal;

means for generating an equalization weight based on the estimated channel response, and equalizing the frequency-domain signal by multiplying an information symbol at each of the plurality of subcarrier positions at which the common phase variation has been compensated for by the equalization weight; and

means for transforming the equalized frequency-domain signal into a time-domain signal.

### Advantageous Effects of Invention

According to the present disclosure, in LOS-MIMO using single-carrier transmission, it is possible to generate orthogonal pilot signals that cause no inter-symbol interference therebetween irrespective of the number of transmitting antennas and the maximum delay time of a multi-path fading channel. Further, according to the present disclosure, it is possible to implement highly efficient pilot signal multiplexing in which the overhead of pilot signals is reduced as compared to that in TDM multiplexing.

Furthermore, according to the present disclosure, it is possible to reduce, in LOS-MIMO using single-carrier transmission, the amount of calculation as compared to that in a demodulation method including an equalizer using the above-described ordinary time-domain process, and including estimation of phase noises and a compensation method therefor.

### BRIEF DESCRIPTION OF DRAWINGS

FIG. 1 shows an example of a configuration of a 2×2 LOS-MIMO system;

FIG. 2 shows an example of a configuration of a TDE using transversal filters;

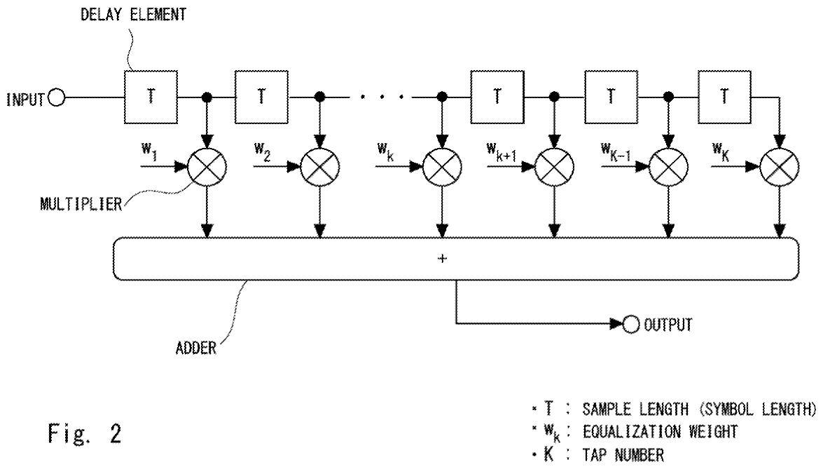

FIG. 3 shows an example of a configuration an FDE;

FIG. 4 is a diagram for explaining a principle of operations according to the CDM multiplexing method for pilot signals using cyclic shifts with different spread codes;

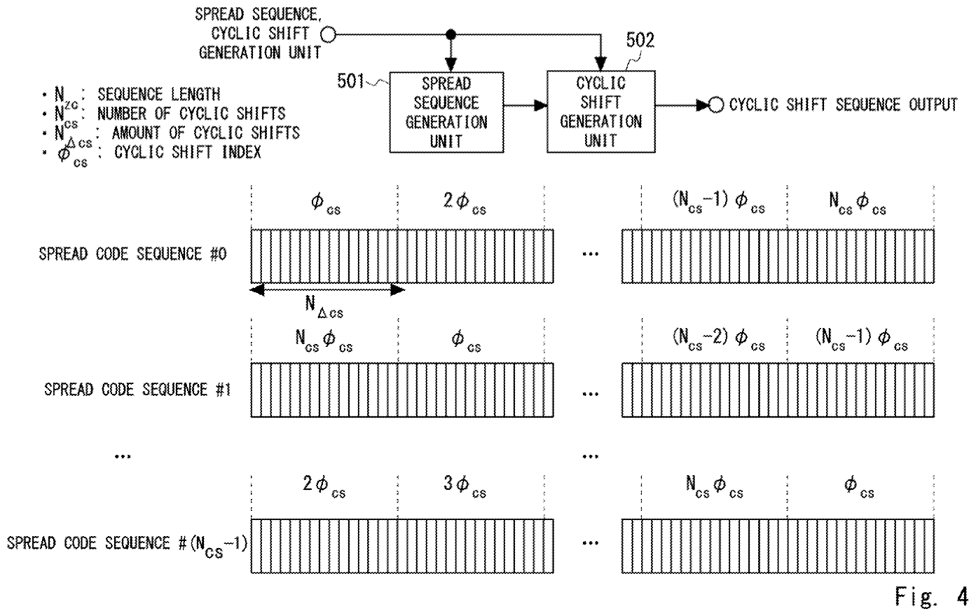

FIG. 5 shows an example of a structure of a frame for single-carrier transmission;

FIG. 6 shows an example of a configuration of a modulation apparatus according to a first example embodiment;

FIG. 7 is a diagram for explaining a method for generating a Distributed FDM signal through a frequency-domain process;

FIG. 8 shows an example of a configuration of a demodulation apparatus according to the first example embodiment;

FIG. 9 is a diagram for explaining a method for separating a Distributed-FDM-multiplexed pilot signal;

FIG. 10 shows an example of a configuration of a modulation apparatus according to a second example embodiment;

FIG. 11 is a diagram for explaining generation of orthogonal pilot signals in which hybrid multiplexing of a cyclic shift CDM and Distributed-FDM is used;

FIG. 12 shows an example of a configuration of a demodulation apparatus according to the second example embodiment;

FIG. 13 is a diagram for explaining a pilot signal separation process performed in a receiver in a case where cyclic shift CDM and Distributed FDM hybrid multiplexing is used;

FIG. 14 is a diagram for explaining an overview of a modulation apparatus according to a third example embodiment;

FIG. 15 shows an example of a configuration of a modulation apparatus according to the third example embodiment;

FIG. 16 shows an example of a basic configuration of a demodulation apparatus;

FIG. 17 shows an example of a configuration of a demodulation apparatus according to a fourth example embodiment;

FIG. 18 is a diagram for explaining a phase-noise estimation method using a pilot signal in a time domain;

FIG. 19 shows an example of a configuration of a demodulation apparatus according to a fifth example embodiment;

FIG. 20 shows an example of a configuration of a phase-noise estimation/compensation unit using a PLL;

FIG. 21 shows an example of a configuration of a demodulation apparatus according to a sixth example embodiment;

FIG. 22 shows an example of a configuration of a demodulation apparatus according to a modified example of the sixth example embodiment;

FIG. 23 shows an example of a configuration of a demodulation apparatus according to a seventh example embodiment;

FIG. 24 shows an example of a configuration of a demodulation apparatus according to an eighth example embodiment;

FIG. 25 shows an example of a configuration of a demodulation apparatus according to a modified example of the eighth example embodiment; and

FIG. 26 shows an example of a configuration of a demodulation apparatus according to a ninth example embodiment.

### DESCRIPTION OF EMBODIMENTS

### First Example Embodiment

Example embodiments according to the present invention will be described hereinafter with reference to the drawings. Note that, in the drawings of the present disclosure, connections between blocks are indicated by arrows. However, they are shown just for the sake of convenience of explanation, and the connections between blocks are not necessarily established according to the directions indicated by the arrows.

### <Highly Efficient Method for Multiplexing Orthogonal Pilot Signals for FDE and Estimation of Phase Noise>

A highly efficient method for multiplexing pilot signals necessary for an FDE and estimation of a phase noise will be described hereinafter.

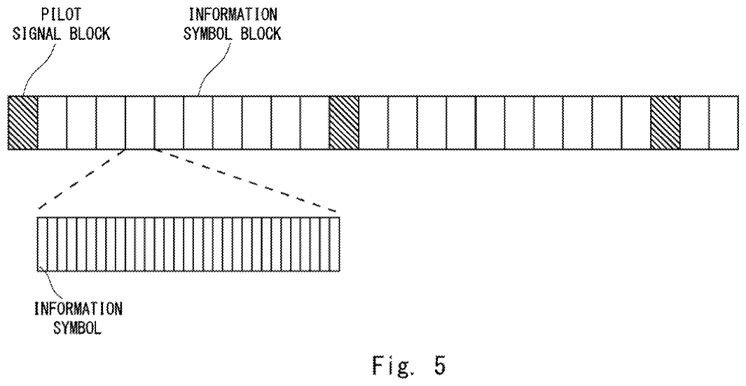

Firstly, a structure of a frame for single-carrier transmission will be described with reference to FIG. 5. FIG. 5 shows an example of a structure of a frame for single-carrier transmission. A plurality of information symbols are grouped together into a block. In general, a symbol length in a block is set to a power of two so that a fast Fourier transform (FFT: Fast Fourier Transform) can be applied when it is transformed into a frequency-domain signal. As shown in FIG. 5, pilot blocks each of which is composed of a plurality of pilot symbols are multiplexed at regular intervals between information symbol blocks each of which is composed of a plurality of information symbols. A cyclic prefix (CP) is added to the head of each pilot block and the head of each information symbol block, and a cyclic suffix (CS) is added to the end thereof. The CP and CS are signals copied from N_{CP} and N_{CS} symbols (samples), respectively, present at the end and head, respectively, of the information symbol block.

When orthogonal pilot signals are multiplexed by time division multiplexing (TDM), a number of pilot blocks corresponding to the number of transmitting antennas are required. In the following, a multiplexing method and a separating method for orthogonal pilot signals using a frequency division multiplexing (FDM), and a multiplexing method and a separating method for hybrid orthogonal pilot signals of CDM and FDM are described by using resources for one pilot block in a time domain.

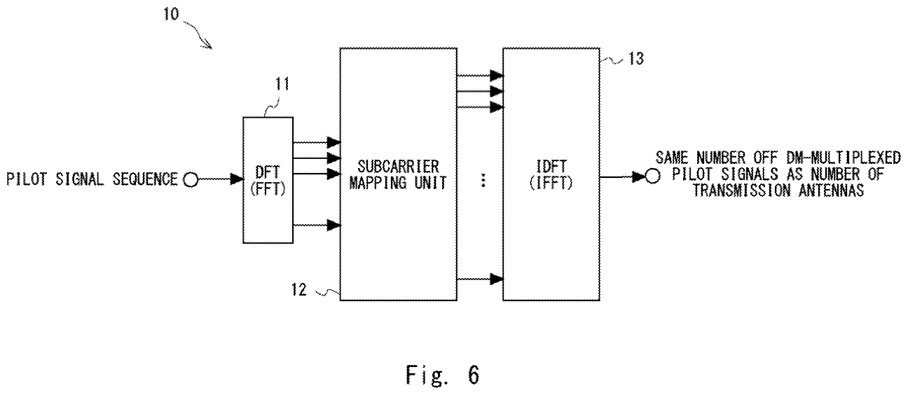

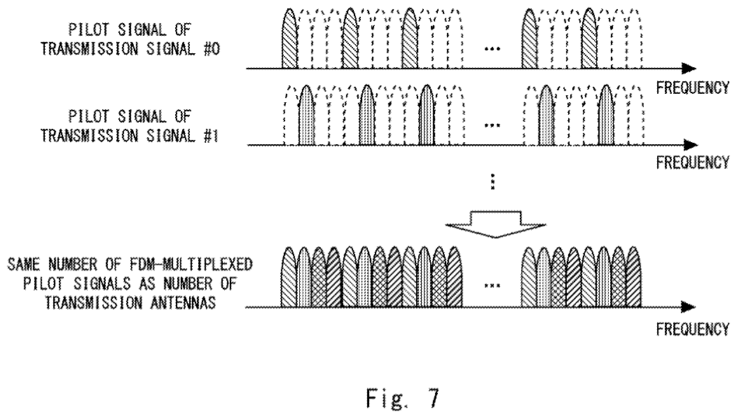

A method for generating Distributed-FDM multiplexing of pilot signals performed in a modulation apparatus 10 will be described with reference to FIGS. 6 and 7. Although it is possible to generate a Distributed-FDM signal by a time-domain process, a method for generating a Distributed-FDM signal by a frequency-domain process will be described hereinafter. FIG. 6 shows an example of a configuration of a modulation apparatus according to the first example embodiment. FIG. 7 is a diagram for explaining a method for generating a Distributed-FDM signal by a frequency-domain process.

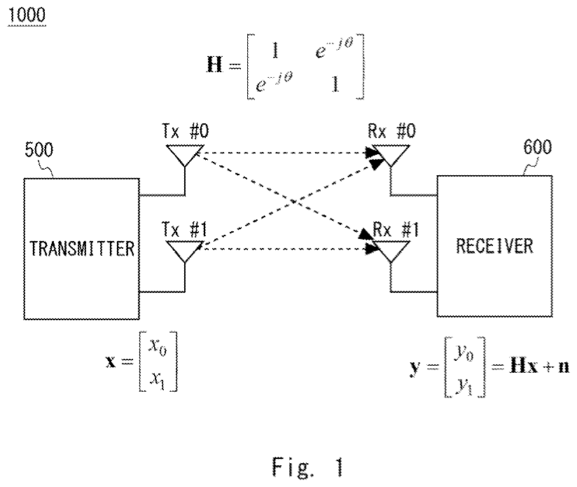

The modulation apparatus 10 is a modulator (modulation apparatus) provided in a transmitting apparatus in a LOS-MIMO radio communication system, which corresponds to the transmitter 500 shown in FIG. 1. As shown in FIG. 6, the modulation apparatus 10 includes a transformation unit 11, a subcarrier mapping unit 12, and an inverse transformation unit 13.

In the following description, the number of subcarriers of a single carrier signal is represented by N_{FFT}, and the number of symbols in a pilot block or a sequence length of a pilot signal is represented by Nₚₗₜ. The modulation apparatus 10 Distributed FDM-multiplexes pilot signals unique to the transmitting antennas in a comb-teeth-like shape in a frequency domain. When the number of multiplexed orthogonal pilot signal corresponding to the number of transmitting antennas is represented by N_{FDM}, it is expressed as N_{FDM}=N_{FFT}/Nₚₗₜ. Note that, in the following description, a term or an expression using “/” indicates a division. For example, when it is expressed as A/B, it indicates that A is divided by B.

The transformation unit 11 transforms a pilot signal having a sequence length Nₚₗₜ in a time domain into a frequency-domain signal through a discrete Fourier transform having the number of stages corresponding to the sequence length Nₚₗₜ. The number of samples in the discrete Fourier transform is expressed ad N_{DFT}=Nₚₗₜ. Note that the transformation unit 11 may transform a pilot signal in the time domain into a frequency-domain signal through a fast Fourier transform.

The subcarrier mapping unit 12 maps Nₚₗₜ subcarrier components (frequency components) (i.e., Nₚₗₜ pieces of subcarrier components) in the frequency domain in a discrete comb-teeth like shape at N_{FDM} subcarrier intervals (i.e., N_{FDM} pieces of subcarrier intervals) by shifting the mapping positions of the heads thereof one after another by an amount equivalent to one subcarrier so that the subcarrier components do not overlap each other.

A method for generating a Distributed FDM signal by a frequency-domain process performed by the subcarrier mapping unit 12 will be described hereinafter with reference to FIG. 7. The subcarrier mapping unit 12 maps pilot signals of the first transmitting antenna in a discrete comb-teeth like shape at N_{FDM} subcarrier intervals from the first subcarrier. The pilot signals of the first transmitting antenna are pilot signals indicated by oblique hatching lines in FIG. 7.

Similarly, the subcarrier mapping unit 12 maps pilot signals of the second transmitting antenna in a discrete manner at N_{FDM} subcarrier intervals from the second subcarrier by shifting the initial subcarrier position by an amount equivalent to one subcarrier. The pilot signals of the second transmitting antenna are pilot signals indicated by vertical hatching lines in FIG. 7.

After that, the subcarrier mapping unit 12 shifts the initial subcarrier position by an amount equivalent to one subcarrier in a similar manner and discretely maps them at N_{FDM} subcarrier intervals. By doing so, the subcarrier mapping unit 12 generates N_{FDM} distributed FDM-multiplexed orthogonal pilot signals (i.e., N_{FDM} pieces of distributed FDM-multiplexed orthogonal pilot signals). As shown in the figure at the bottom FIG. 7, the subcarrier mapping unit 12 generates N_{FDM} Distributed-FDM-multiplexed orthogonal pilot signals.

Returning to FIG. 6 again, the inverse transformation unit 13 will be described. The inverse transformation unit 13 transforms the frequency-domain signal of the N_{FFT} subcarriers in which all the pilot signals have been mapped into a time-domain signal through an inverse discrete Fourier transform. Alternatively, the inverse transformation unit 13 may transform the signal into a time-domain signal through an inverse fast Fourier transform.

The inverse transformation unit 13 sets the transformed time-domain signal in a pilot block composed of discrete orthogonally-multiplexed pilot signals. Pilot blocks are multiplexed at regular intervals between information symbols. Further, a CP and CS are added to the head and end, respectively, of each pilot block.

Pilot signals of different transmitting antennas are orthogonally multiplexed by Distributed FDM. Therefore, the same pilot signal sequence can be used in different transmitting antennas, or different pilot signal sequences may be used therein. Because of the single carrier signal, discretely mapped subcarrier signals of the transmitting antennas are the same as each other. Therefore, it is possible to achieve a low PAPR (Peak to Average Power Ratio) by using the modulation apparatus 10 as in the case of the ordinary single carrier signal.

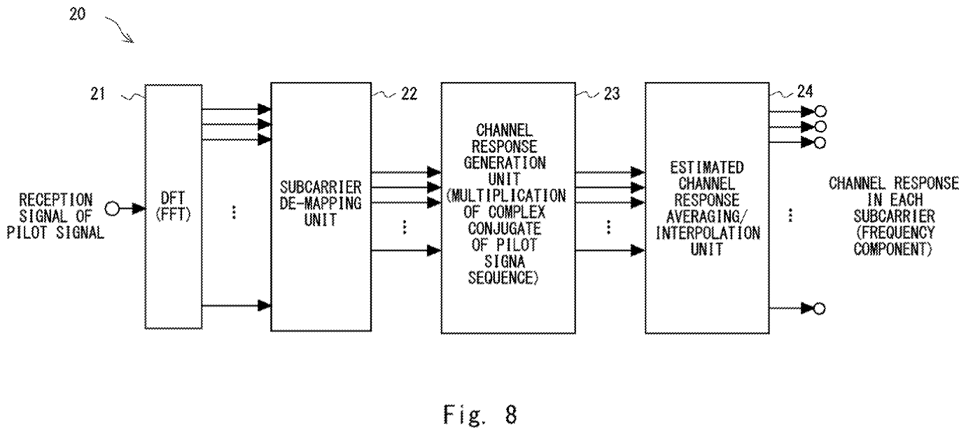

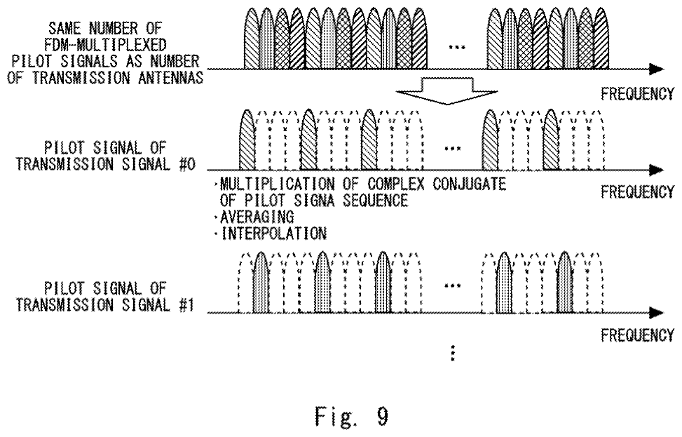

Next, a method for separating a Distributed-FDM-multiplexed pilot signal in a demodulation apparatus 20 will be described with reference to FIGS. 8 and 9. FIG. 8 shows an example of a configuration of a demodulation apparatus according to a first example embodiment. FIG. 9 is a diagram for explaining a method for separating a Distributed-FDM-multiplexed pilot signal.

The demodulation apparatus 20 is a demodulator (demodulation apparatus) provided in a receiving apparatus in a LOS-MIMO radio communication system, and is a modulator (modulation apparatus) provided in a receiving apparatus corresponding to the receiver 600 shown in FIG. 1. As shown in FIG. 8, the demodulation apparatus 20 includes a transformation unit 21, a subcarrier de-mapping unit 22, a channel response generation unit 23, and an averaging/interpolation unit 24. Here, each component/structure provided in the demodulation apparatus 20 will be described by referring to FIG. 9 as appropriate.

After the CP and CS are removed from a pilot block contained in the reception signal, the transformation unit 21 converts it into a frequency-domain signal through a discrete Fourier transform. Note that the transformation unit 21 may transform it into a frequency-domain signal through a fast Fourier transform.

The subcarrier de-mapping unit 22 discretely extracts a pilot signal unique to each transmission signal. The subcarrier de-mapping unit 22 extracts subcarrier signals of the same number of pilot signals as the number of transmitting antennas at the same number of subcarrier intervals as the number of transmitting antennas by shifting the first subcarrier position from the FDM-multiplexed frequency-domain pilot signal.

The figure at the top in FIG. 9 shows a number of FDM-multiplexed pilot signals corresponding to the number of transmitting antennas, and the second and third figures in FIG. 9 show pilot signals extracted for the respective transmitting antennas provided in the transmitting apparatus including the modulation apparatus 10. The subcarrier de-mapping unit 22 extracts the FDM-multiplexed pilot signals shown in the figure at the top in FIG. 9 for each transmitting antenna.

The channel response generation unit 23 generates a channel response at each subcarrier position. The channel response generation unit 23 generates a channel response by multiplying the subcarrier signal of the extracted pilot signal by a complex conjugate of the pilot signal sequence in the frequency domain and thereby removing the modulation component of the pilot signal sequence. As shown in the second and third figures in FIG. 9, the channel response generation unit 23 multiplies the subcarrier signal of the extracted pilot signal by the complex conjugate of the pilot signal sequence in the frequency domain.

The averaging/interpolation unit (averaging and interpolation unit) 204 functions as averaging means and interpolation means. The averaging/interpolation unit 24 averages estimated values of channel responses at a plurality of discrete subcarrier positions. The averaging/interpolation unit 24 averages, in each subcarrier of each of the same number of pilot signals as the number of receiving antennas provided in the receiving apparatus which includes the own apparatus, channel responses at a plurality of subcarrier positions spaced apart at the same number of subcarrier intervals as the number of receiving antennas. A channel response at each subcarrier position is highly affected by noises. Therefore, the averaging/interpolation unit 24 reduces noise components by averaging estimated values of channel responses at a plurality of discrete subcarrier positions.

The averaging/interpolation unit 24 estimates channel responses at subcarrier positions where information symbols are multiplexed by interpolating channels or the like at subcarrier positions where pilot signals are multiplexed. The averaging/interpolation unit 24 estimates a channel response at a subcarrier position between subcarriers at each of which a respective one of the same number of pilot signals as the number of receiving antennas are multiplexed by interpolating the averaged channel response in each subcarrier of each of the same number of pilot signals as the number of receiving antennas.

The averaging/interpolation unit 24 can also simultaneously average and interpolate estimated values of channel responses at a plurality of discrete subcarrier positions by using a minimum mean square error (MMSE: Minimum Mean Square Error) filter.

In the first example embodiment, orthogonal multiplexing of pilot signals unique to transmission signals transmitted from different transmitting antennas using frequency division multiplexing (FDM: Frequency Division Multiplexing) in LOS-MIMO using single-carrier transmission has been described. In principle, there is no restriction on the number of orthogonal pilot signals in FDM multiplexing, and it has an advantageous effect that it does not cause an increase in the peak-to-average power ratio (PAPR: Peak-to-Average Power Ratio).

### Second Example Embodiment

Next, a second example embodiment will be described. The second example embodiment is an example embodiment related to hybrid multiplexing of cyclic shift CDM and Distributed FDM. As described above, in pilot signal multiplexing using cyclic shift CDM, it is necessary to set the cyclic shift amount to a value equal to or longer than the maximum delay time of multiple paths. However, as the number of transmitting antennas increases, the number of cyclic shift sequences needs to be increased, so that the cyclic shift amount N_{ΔCS} becomes shorter. Therefore, in order to relax the constraint on the maximum permissible cyclic shift number, which is determined by the maximum delay time of cyclic shift CDM multiplexed multi-path fading channels, orthogonal pilot signals are generated by using hybrid multiplexing of cyclic shift CDM and Distributed FDM.

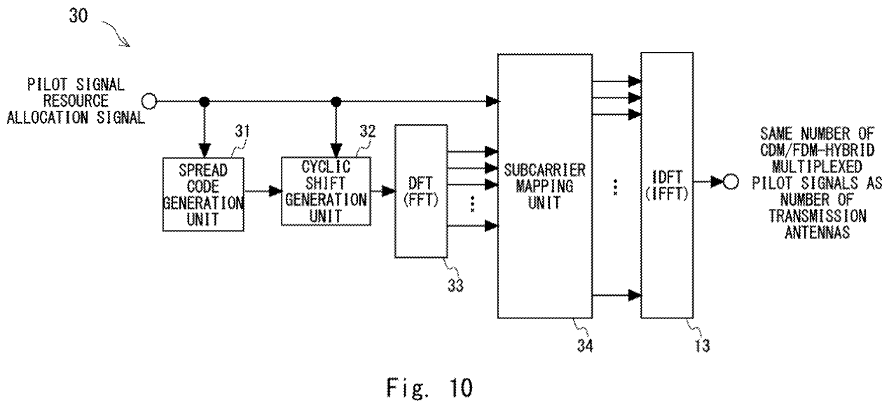

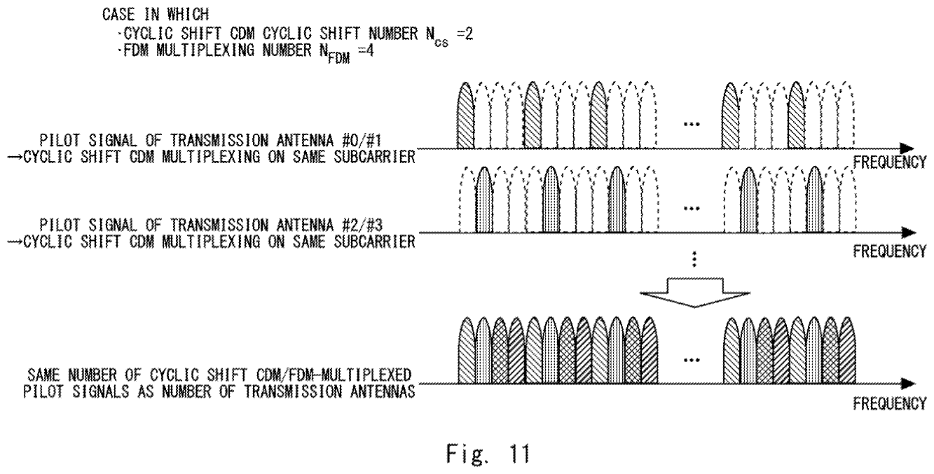

An example of a configuration of a modulation apparatus 30 according to the second example embodiment and generation of orthogonal pilot signals using hybrid multiplexing of cyclic shift CDM and Distributed FDM will be described with reference to FIGS. 10 and 11. FIG. 10 shows an example of a configuration of a modulation apparatus according to the second example embodiment. FIG. 11 is a diagram for explaining generation of orthogonal pilot signals using hybrid multiplexing of cyclic shift CDM and Distributed FDM. FIG. 11 shows an example case where the number N_{CS} of cyclic shifts is two (N_{CS}=2) and the number N_{FDM} of Distributed FDM multiplexing is four (N_{FDM}=4).

As shown in FIG. 10, the modulation apparatus 30 includes a spread code generation unit 31, a cyclic shift generation unit 32, a transformation unit 33, a subcarrier mapping unit 34, and an inverse transformation unit 13. Note that the inverse transformation unit 13 is similar to that in the second example embodiment, and therefore its description is omitted.

The spread code generation unit 31, for which spread codes of pilot signals unique to transmitting antennas are specified by a control unit (not shown), generates spread codes such as a Zadoff-Chu sequence, and inputs (i.e., supplies) the generated spread codes to the cyclic shift generation unit 32.

The cyclic shift generation unit 32, for which cyclic shift amounts of the pilot signals unique to the transmitting antennas are specified by the control unit (not shown), generates cyclic shift sequences having different numbers of cyclic shifts corresponding to the number of users of which signals are multiplexed at the same time. The cyclic shift generation unit 32 generates a cyclic shift sequence having a number of cyclic shifts by cyclically shifting the generated spread code a number of times that is obtained by dividing the sequence length of that spread code by the number of cyclic shifts.

The transformation unit 33 transforms the cyclic-shift-spread pilot signal having a sequence length Nₚₗₜ into a frequency-domain signal through a discrete Fourier transform. The transformation unit 33 transforms the same number of pilot signals as the cyclic shift number, which have the sequence length Nₚₗₜ, into frequency-domain signals through a discrete Fourier transform having the number of stages corresponding to the sequence length Nₚₗₜ. The number NDFT of samples in the discrete Fourier transform is Nₚₗₜ (N_{DFT}=Nₚₗₜ). Note that the transformation unit 33 may transform it into a frequency-domain signal through a fast Fourier transform.

The subcarrier mapping unit 34, for which subcarrier positions are specified by the control unit (not shown), maps the pilot signals of the respective transmitting antennas in a discrete comb-teeth like shape at N_{FDM} subcarrier intervals.

Mapping performed by the subcarrier mapping unit 34 will be described with reference to FIG. 11. The subcarrier mapping unit 34 maps the pilot signals of the first and second transmitting antennas in a discrete comb-teeth like shape, starting from the first subcarrier, at N_{FDM} subcarrier intervals. As shown in the figure at the top in FIG. 11, the subcarrier mapping unit 34 maps the pilot signals of the first transmitting antenna (transmitting antenna #0) and the second transmitting antenna (transmitting antenna #1) in a discrete comb-teeth like shape, starting from the first subcarrier, at N_{FDM} subcarrier intervals as shown by subcarriers indicated by oblique hatching lines. When the number of transmitting antennas is represented by N_{Tx}, the number N_{FDM} is expressed as N_{FDM}=N_{Tx}/N_{CS}. Therefore, as compared to the case where pilot signals are orthogonally multiplexed by using only the Distributed FDM, it is possible to narrow (i.e., reduce) the inter-subcarrier interval N_{FDM} at which pilot signals are multiplexed by the amount N_{CS}. Therefore, it is possible to improve the accuracy of the estimation of channel responses in the frequency domain in the frequency-selectivity fading channel.

As shown in the second figure in FIG. 11, the subcarrier mapping unit 34 maps the pilot signals of the third transmitting antenna (transmitting antenna #2) and the fourth transmitting antenna (transmitting antenna #3) in a discrete comb-teeth like shape, starting from the second subcarrier, at N_{FDM} subcarrier intervals as shown by subcarriers indicated by horizontal hatching lines. That is, the subcarrier mapping unit 34 discretely maps pilot signals of 2t-th and (2t+1)th transmitting antennas, starting from a (t+1)th subcarrier, at N_{FDM} subcarrier intervals by shifting the initial subcarrier position by an amount equivalent to one subcarrier. Note that t is an integer equal to or larger than zero.

After that, the subcarrier mapping unit 34 discretely maps the subsequent pilot signals at N_{FDM} subcarrier intervals by shifting the initial subcarrier position by an amount equivalent to one subcarrier in a similar manner. As a result, as shown in the figure at the bottom of FIG. 11, the subcarrier mapping unit 34 can generate N_{CS}×N_{FDM} orthogonal pilot signals (i.e., N_{CS}×N_{FDM} pieces of orthogonal pilot signals) using cyclic shift CDM and Distributed FDM hybrid multiplexing.

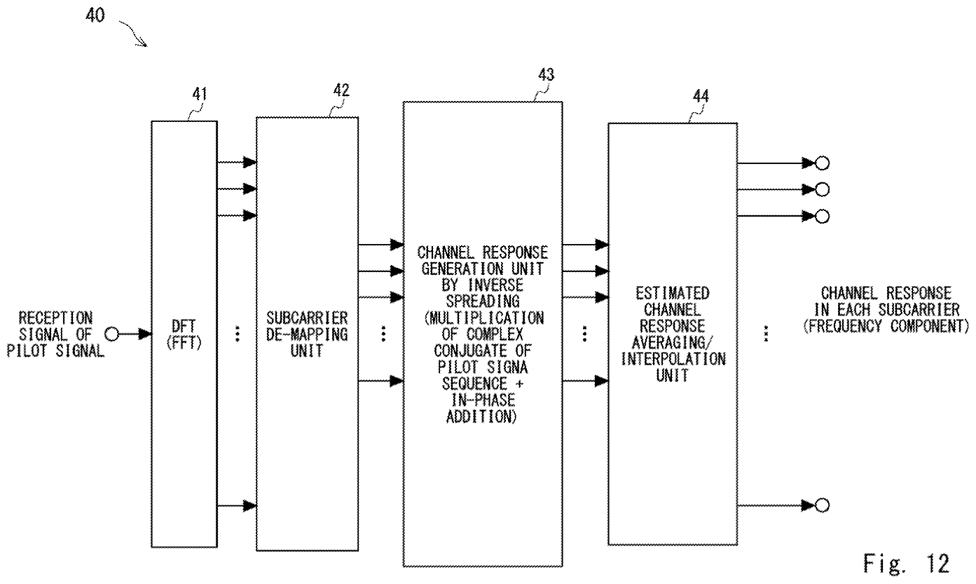

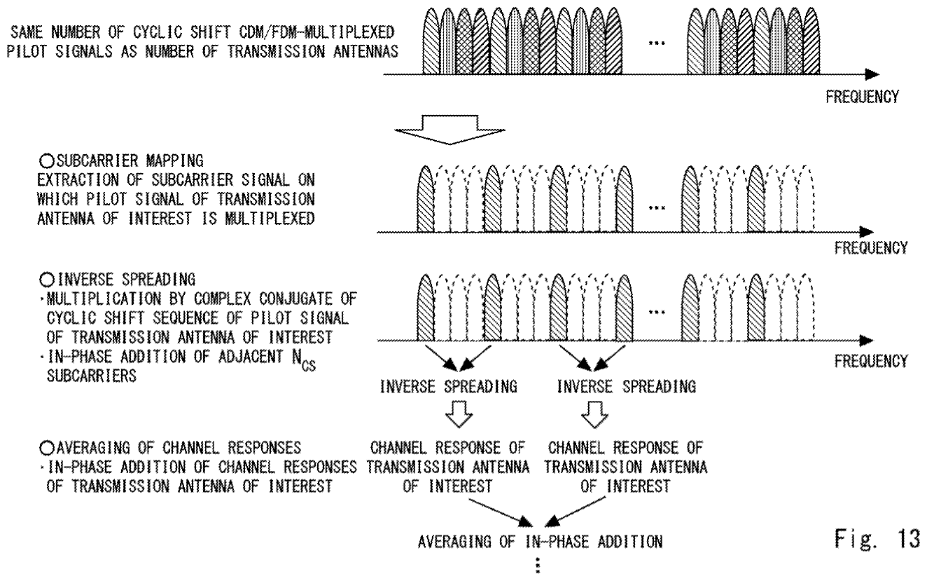

Next, an example of a configuration of a demodulation apparatus 40 will be described with reference to FIGS. 12 and 13, and a pilot signal separation process using cyclic shift CDM and Distributed FDM hybrid multiplexing performed in the demodulation apparatus 40 will be described. FIG. 12 shows an example of a configuration of a demodulation apparatus according to the second example embodiment. FIG. 13 is a diagram for explaining a pilot signal separation process performed in a receiver in a case where cyclic shift CDM and Distributed FDM hybrid multiplexing is used.

The demodulation apparatus 40 includes a transformation unit 41, a subcarrier de-mapping unit 42, a channel response generation unit 43, and an averaging/interpolation unit 44.

After the CP and CS are removed from a pilot block contained in the reception signal, the transformation unit 41 converts it into a frequency-domain signal through a discrete Fourier transform. Note that the transformation unit 41 may transform it into a frequency-domain signal through a fast Fourier transform.

The subcarrier de-mapping unit 42 discretely extracts a pilot signal unique to each transmission signal. The subcarrier de-mapping unit 42 extracts subcarrier signals of the same number of pilot signals as the number of predetermined subcarrier intervals at predetermined subcarrier intervals by shifting the first subcarrier position from the CDM and FDM multiplexed frequency-domain pilot signal. The subcarrier interval is a number obtained by dividing the number of receiving antennas by the number of cyclic shifts of the pilot signals.

The figure at the top in FIG. 12 shows a number of cyclic shift CDM and FDM multiplexed pilot signals corresponding to the number of transmitting antennas. The second figure in FIG. 12 shows operations performed by the subcarrier de-mapping unit 42. The subcarrier de-mapping unit 42 extracts subcarrier signals on which pilot signals of a transmitting antenna of interest are multiplexed.

The channel response generation unit 43 generates a channel response through inverse spreading. The channel response generation unit 43 generates the channel response by multiplying the subcarrier signal of the extracted pilot signal by a complex conjugate of the cyclic shift sequence of the pilot signal in the frequency domain, and then adding N_{CS} signals (i.e., N_{CS} pieces of signals) at N_{FDM} intervals in an in-phase manner. The third figure in FIG. 12 shows operations performed by the channel response generation unit 43. The channel response generation unit 43 multiplies the subcarrier signal by the complex conjugate of the cyclic shift sequence of the pilot signal of the transmitting antenna of interest. The channel response generation unit 43 generates a channel response by adding N_{CS} signals at N_{FDM} intervals in an in-phase manner.

By the discrete Fourier transform, a shift in the time domain corresponds to a phase rotation process in the frequency domain. For the cyclic shift number N_{CS} in the time domain, a phase shift of 2π/N_{CS} occurs for each subcarrier in the frequency domain. Therefore, since the amount of the phase rotation between the discretely mapped N_{CS} subcarriers becomes 2π, the cross-correlation of the code between the N_{CS} subcarriers becomes zero.

The averaging/interpolation unit 45 averages estimated values of channel responses for the same transmitting antenna for which the inverse spreading has already been performed. Since the subcarrier de-mapping and the channel responses for which the inverse spreading has already been performed are highly affected by noises, the averaging/interpolation unit 45 reduces noise components by averaging the estimated values of the channel responses for the same transmitting antenna for which the inverse spreading has already been performed.

The averaging/interpolation unit 45 functions as means for averaging and means for interpolation. The averaging/interpolation unit 45 estimates channel responses at subcarrier positions where information symbols are multiplexed by interpolating channels or the like at subcarrier positions where pilot signals are multiplexed. The averaging/interpolation unit 45 can also simultaneously average and interpolate estimated values of channel responses at a plurality of discrete subcarrier positions by using a minimum mean square error (MMSE: Minimum Mean Square Error) filter.

As described above, an orthogonal pilot signal multiplexing method using hybrid multiplexing of cyclic shift CDM and FDM has been described in the second example embodiment. According to the second example embodiment, it is possible to relax the constraint on the maximum permissible cyclic shift number, which is determined by the maximum delay time of the cyclic shift CDM multiplexed multi-path fading channels.

### Third Example Embodiment

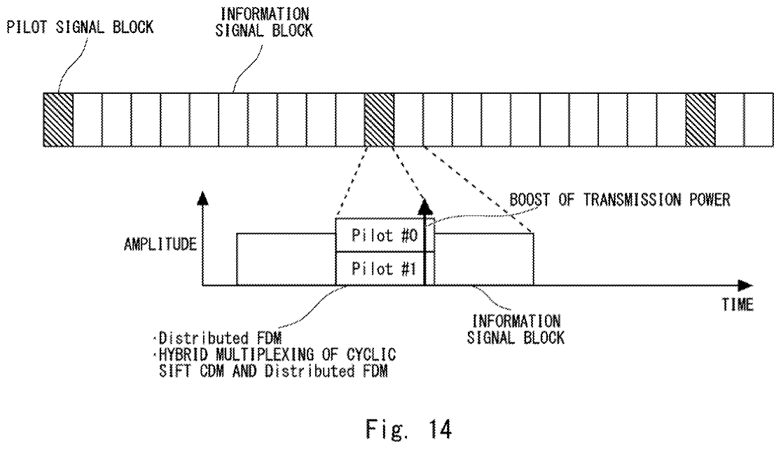

Next, a third example embodiment will be described. In the third example embodiment, the modulation apparatus has a function of boosting pilot signals and performs operations for boosting pilot signals. Firstly, an overview of a modulation apparatus according to the third example embodiment will be described with reference to FIG. 14. FIG. 14 is a diagram for explaining an overview of a modulation apparatus according to the third example embodiment.

As shown in FIG. 14, pilot signal blocks and information symbol blocks are TDM-multiplexed in both the Distributed FDM multiplexing according to the first example embodiment and the hybrid multiplexing of cyclic shift CDM and Distributed FDM according to the second example embodiment.

The accuracy of the estimation of a channel response of each subcarrier (frequency component) using a pilot signal affects the accuracy of an equalization weight of a frequency domain equalization (FDE), the accuracy of the estimation of phase noises, and the like. Therefore, even when the transmission power (and hence the reception power) of the information symbol is the same, the reception SNR (signal-to-noise ratio) of the pilot signal is improved by increasing (boosting) the transmission power (and hence the reception power) of the pilot signal, so that the accuracy of the FDE equalization weight and the accuracy of the estimation of phase noises are improved. As a result, it is possible to improve the bit error rate of information symbols. Therefore, a modulation apparatus according to the third example embodiment has a function of boosting the transmission power of a pilot signal unique to each transmitting antenna in order to enable an information symbol to meet a required reception bit error rate according to the receiving condition of the receiver, i.e., according to the reception SNR.

The control of the transmission power of a pilot signal does not need to be performed fast enough to be able to follow the fading variations. That is, it is sufficient even if the control is performed at very long intervals, such as being performed, for example, when the base station is installed or when the interference condition in the vicinity thereof has changed, so that the average SNR becomes a required reception SNR that meets a required bit error rate.

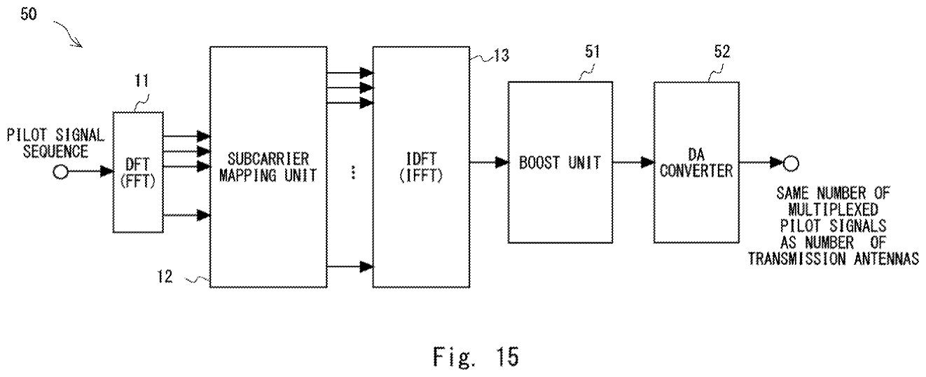

A modulation apparatus 50 according to the third example embodiment will be described with reference to FIG. 15. FIG. 15 shows an example of a configuration of the modulation apparatus according to the third example embodiment. FIG. 15 shows the modulation apparatus 50 according to the third example embodiment which is configured based on the modulation apparatus 10 according to the first example embodiment. If the modulation apparatus 50 is configured based on the modulation apparatus 30 according to the second example embodiment, it will be configured with a boost unit 51 and a DA (Digital-to-Analog) converter 52 disposed behind (i.e., on the output side of) the inverse transformation unit 13. Note that although not shown in FIG. 6 and FIG. 10, each of the modulation apparatus 10 according to the first example embodiment and the modulation apparatus 30 according to the second example embodiment also includes a DA converter 52.

The boost unit 51 boosts the transmission power of a pilot signal. The boost unit 51 receives a message requesting to increase or decrease the transmission power of a pilot signal from a receiving apparatus opposed to the modulation apparatus 50. The receiving apparatus measures an error rate, determines whether or not to increase or decrease the transmission power of the pilot signal depending on whether or not the measured error rate meets a target error rate, and transmits the aforementioned message containing information about the determination. The boost unit 51 performs control to increase or decrease the transmission power according to the received message.

The boost unit 51 multiplies a digital signal which has been obtained by performing FDM, CDM and FDM multiplexing on pilot signals of a plurality of transmitting antennas, which have been IDFT-transformed by and output from the inverse transformation unit 13, by a factor for multiplying the amplitude to be boosted, or shifts the bits thereof. In this way, the boost unit 51 can easily implement its function by multiplying the signal by a factor for multiplying the amplitude to be boosted, or shifts the bits thereof.

The DA converter 52 converts the digital signal into an analog signal. The boost unit 51 may be disposed behind (i.e., on the output side of) the DA converter 52, instead of being disposed in front of (i.e., on the input side of) the DA converter 52, and may amplify the analog signal obtained by the DA conversion performed by the DA converter 52. Even in this way, it is also possible to boost the transmission power of a pilot signal, but it is easier to amplify the digital signal before the DA conversion.

For example, as shown in Non-patent Literature 8, in the 3GPP (3rd Generation Partnership Project), the standardization of radio standards for a scheme in which a wireless access link called IAB (Integrated Access and Backhaul) and a wireless back-haul link are integrated with each other has been underway. This scheme is a scheme for realizing wireless back-haul based on the NR (New Radio) radio standards of the 5G for the wireless access link. It is assumed that IAB will be applied to wireless back-haul between a centralized base station (called an IAB donor) and a relay base station (called an IAB node). In particular, in the IAB, an environment in which there are a large number of relay base stations in a small cell is assumed, and therefore interference between relay base stations also poses a challenge. In such an environment where there are a large number of relay base stations in a small cell, the above-described function of boosting the transmission power of a pilot signal possessed by the modulation apparatus 50 becomes effective.

### Fourth Example Embodiment

### <Configuration of Demodulation Apparatus Including FDE, and Estimation of Phase Noise and Compensation Therefor>

In a fourth example embodiment, a configuration of a demodulation apparatus provided in a receiver in a 2×2 LOS-MIMO radio communication system will be described. Specifically, a demodulation apparatus that performs estimation of phase noises and compensation therefor suitable for FDM in LOS-MIMO using single-carrier transmission, and performs them through a time-domain process and a frequency-domain process will be described.

Note that the 2×2 LOS-MIMO radio communication system is merely an example of the LOS-MIMO radio communication system, so each of the number of transmitting antennas and that of receiving antennas is not limited to two. Further, in each of the subsequent example embodiments, a demodulation apparatus provided in a receiver in a 2×2 LOS-MIMO radio communication system will be described as in the case of the fourth example embodiment.

In LOS-MIMO, it is necessary to set the distance between the antennas of a transmitter and those of a receiver to a large value, so each of the antennas includes an independent base oscillator. Therefore, it becomes a model in which each of the two sets of transmitters and receivers each including two antennas receives an independent phase noise. Pilot symbols are inserted at such intervals that phase variations caused by phase noises are considered to be roughly constant. In the transmitter and the receiver, when attention is paid to an arbitrary slot corresponding to the insertion period of a pilot symbol, the phase variations caused by phase noises in branches 0 and 1 are represented by the below-shown symbols.

ϕ₀^{(T)},ϕ₁^{(T)},ϕ₀^{(R)},ϕ₁^{(R)} [Expression 5]

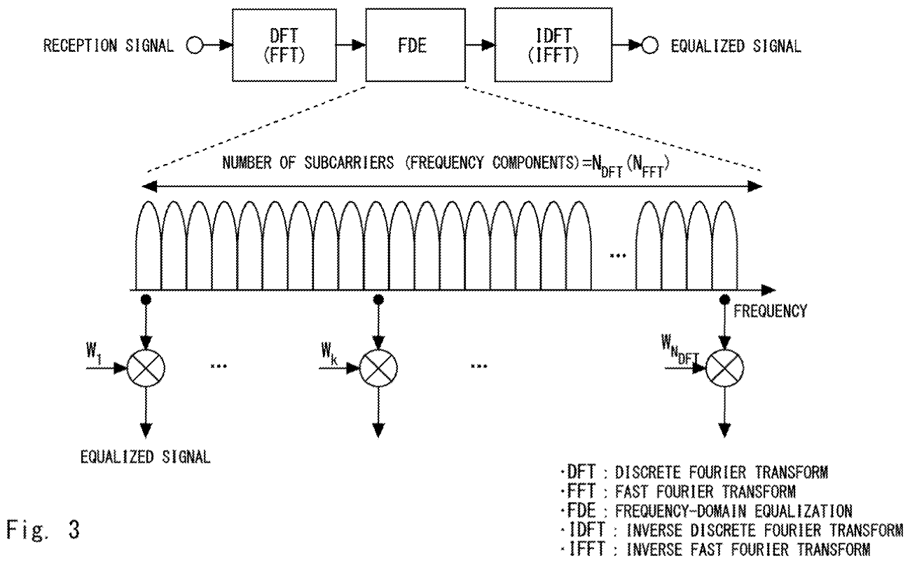

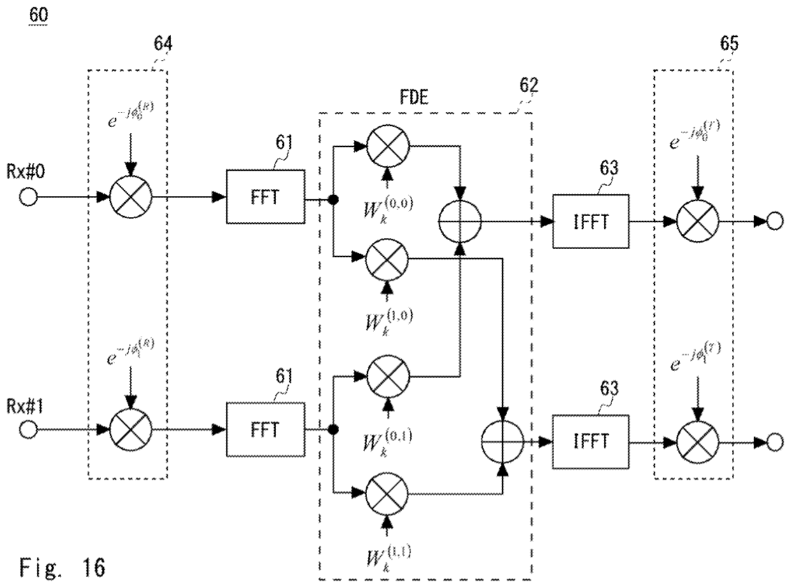

Firstly, a basic configuration of a demodulation apparatus in a 2×2 LOS-MIMO radio communication system will be described with reference to FIG. 16. FIG. 16 shows an example of the basic configuration of the demodulation apparatus. The demodulation apparatus 60 shown in FIG. 16 shows a basic configuration of a demodulation apparatus in a 2×2 LOS-MIMO radio communication system, and corresponds to the FDE configuration shown in FIG. 3. The demodulation apparatus 60 includes the FFT 61, the FDE 62, and the IFFT 63 shown in FIG. 3. Further, the demodulation apparatus 60 includes phase variation compensation units 64 and 65 that compensate for phase noises in the branches 0 and 1 in the transmitter and the receiver.

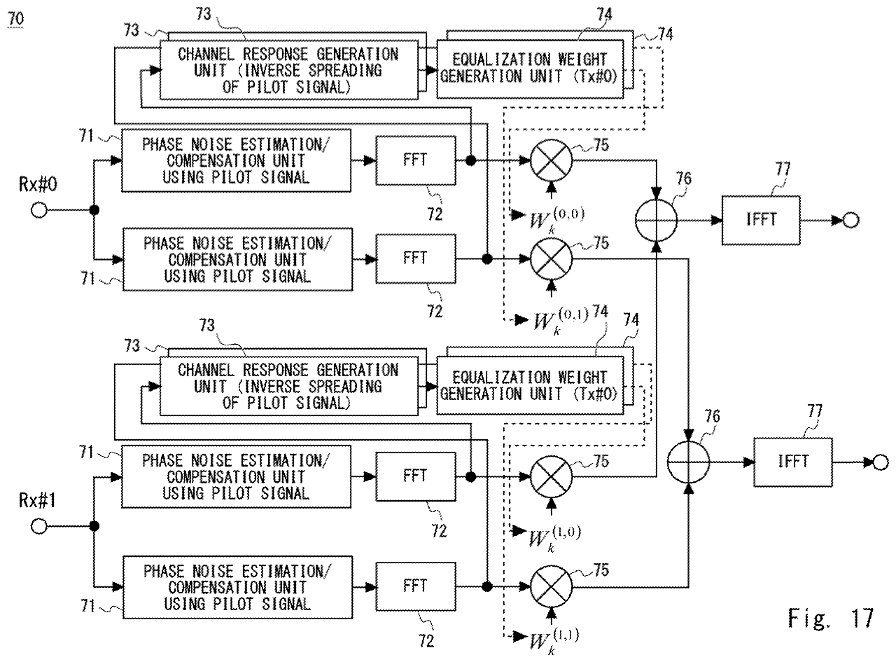

Next, an example of a configuration of a demodulation apparatus 70 in 2×2 LOS-MIMO will be described with reference to FIG. 17. FIG. 17 shows an example of a configuration of the demodulation apparatus according to the fourth example embodiment. The demodulation apparatus 70 includes a phase-noise estimation/compensation unit (phase-noise estimation and compensation unit) 71 that uses a pilot signal, a transformation unit 72, a channel response generation unit 73 that performs frequency-domain inversion spreading of a pilot signal, an equalization weight generation unit 74, an equalization weight multiplication unit 75, an addition unit 76, and an inverse transformation unit 77.

The phase-noise estimation/compensation unit 71 generates an estimated value of a channel response corresponding to each transmitting antenna by performing inverse spreading on a pilot signal of a reception signal in the time domain. The phase-noise estimation/compensation unit 71 estimates channel responses of transmission signals transmitted from a plurality of transmitting antennas by using pilot signals multiplexed in pilot blocks inserted at regular intervals between information symbol blocks.

The phase-noise estimation/compensation unit 71 estimates a phase variation caused by a phase noise at a pilot block position from the channel response estimated based on periodically-multiplexed pilot signals. The phase-noise estimation/compensation unit 71 estimates phase variations expressed by the below-shown expressions for the receiving antenna #0 of the receiver.

ϕ₀^{(T)}+ϕ₀^{(R)} and ϕ₁^{(T)}+ϕ₀^{(R)} [Expression 6]

Further, the phase-noise estimation/compensation unit 71 estimate phase variations expressed by the below-shown expressions for the receiving antenna #1.

ϕ₀^{(T)}+ϕ₁^{(R)} and ϕ₁^{(T)}+ϕ₁^{(R)} [Expression 7]

The phase-noise estimation/compensation unit 71 averages channel responses of a plurality of pilot blocks by using a filter for a weighted moving average or a minimum mean square error (MMSE: Minimum Mean Square Error) criterion, and thereby reduces noise components superimposed on the pilot signals.

The phase-noise estimation/compensation unit 71 generates and compensates for a phase variation at an information symbol position between pilot blocks by interpolating a phase variation caused by a phase noise at a pilot block position. The phase-noise estimation/compensation unit 71 obtains a channel response at an information symbol position between pilot blocks by interpolating a channel response of a pilot block. Linear interpolation, quadratic interpolation, or the like can be used for the interpolation. The phase-noise estimation/compensation unit 71 compensates for the phase noise by multiplying the information symbol by the inverse phase of the phase variation caused by the phase noise at the information symbol position. The phase-noise estimation/compensation unit 71 outputs the signal which has been compensated for the phase noise to the transformation unit 72.

The transformation unit 72 transforms four signals which have been compensated for the phase noises into frequency-domain signals through a discrete Fourier transform. In the demodulation apparatus 70, the transformation unit 72 that performs four discrete Fourier transforms is required. Note that the transformation unit 72 may transform them into frequency-domain signals through a fast Fourier transform.

The channel response generation unit 73 estimates a channel response, at each subcarrier position, to each transmission signal transmitted from a respective one of the transmitting antennas by performing inverse spreading on the pilot signal which has been transformed into the frequency-domain signal.

The equalization weight generation unit 74 generates an equalization weight of a minimum mean square error (MMSE: Minimum Mean Square Error) criterion from the estimated value of the channel response.

The equalization weight multiplication unit 75 performs frequency-domain equalization by multiplying the information symbol of each subcarrier signal of the reception signal by the equalization weight generated by the equalization weight generation unit 74.

The addition unit 76 performs diversity synthesis by adding, in an in-phase manner, the signals which have been transmitted by the same transmission antenna, received by the two antennas, and subjected the frequency-domain equalization.

The inverse transformation unit 77 transforms the diversity-synthesized signal into a time-domain signal through an inverse discrete Fourier transform. For the time-domain signal transformed by the inverse transformation unit 77, a log-likelihood ratio (LLR: Log-Likelihood Ratio) of each bit of each information symbol in the time domain is calculated. Then, after performing de-interleaving on the calculated LLR, it is input to an error-correcting decoder. Note that the inverse transformation unit 77 may transform it into a time-domain signal through an inverse fast Fourier transform.

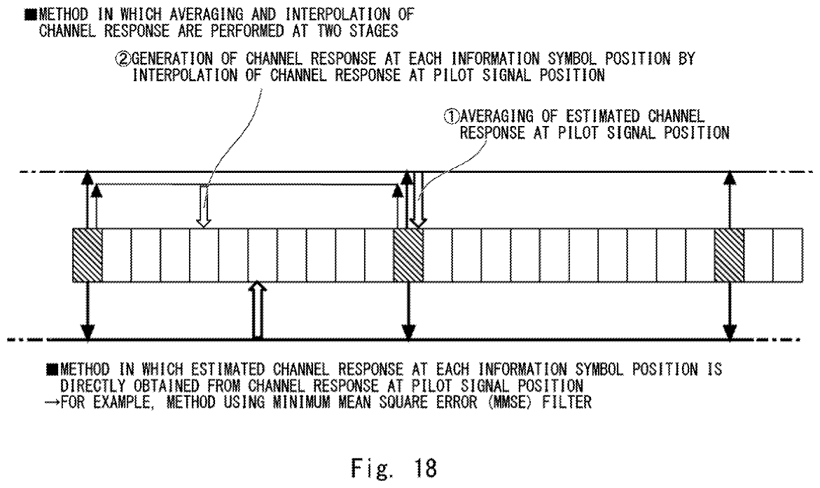

Next, a phase noise estimation method using a pilot signal in the time domain in the demodulation apparatus 70 will be described with reference to FIG. 18. FIG. 18 is a diagram for explaining a phase noise estimation method using a pilot signal in the time domain.

Blocks shown in FIG. 18 represent a structure of a frame for single-carrier transmission, and blocks indicated by oblique hatching lines represent pilot signal blocks. Further, blocks with no hatching line indicate information symbol blocks. Further, FIG. 18 is a diagram for explaining two phase noise estimation methods. Arrows shown above the block diagram showing the frame structure represent a first method in which averaging and interpolation of channel responses are performed at two stages. Arrows shown below the block diagram showing the frame structure represent a second method in which an estimated value of a channel response at each information symbol position is directly obtained.

Firstly, the first method will be described. The phase noise estimation/compensation unit 71 estimates phase variations caused by phase noises at periodically-multiplexed pilot signal positions. The phase noise estimation/compensation unit 71 reduces the influence of noises by averaging estimated values of moving variations of a plurality of pilot signal blocks. However, the correlation of phase variations between pilot signal blocks of which the time interval is larger is small. Therefore, the averaging may adversely lead to an increase in the estimation error of phase variations. Therefore, for example, as disclosed in Non-patent Literature 5 in related art, a method for averaging estimated values of phase variations of a plurality of pilot signal blocks by using a Wiener filter of an MMSE criterion has been proposed. The phase noise estimation/compensation unit 71 interpolates an estimated value of a phase variation of pilot signal blocks, and thereby estimates a phase variation at an information-symbol position between them.

Next, the second method will be described. It is possible to, by using an MMSE filter, directly obtain a phase variation at an information symbol position from an estimated value of a phase variation of a pilot signal block. Therefore, the phase noise estimation/compensation unit 71 can also directly obtain an estimated value of a channel response at each information symbol position based on an estimated value of a phase variation of a pilot signal block by using the MMSE filter.

### Fifth Example Embodiment

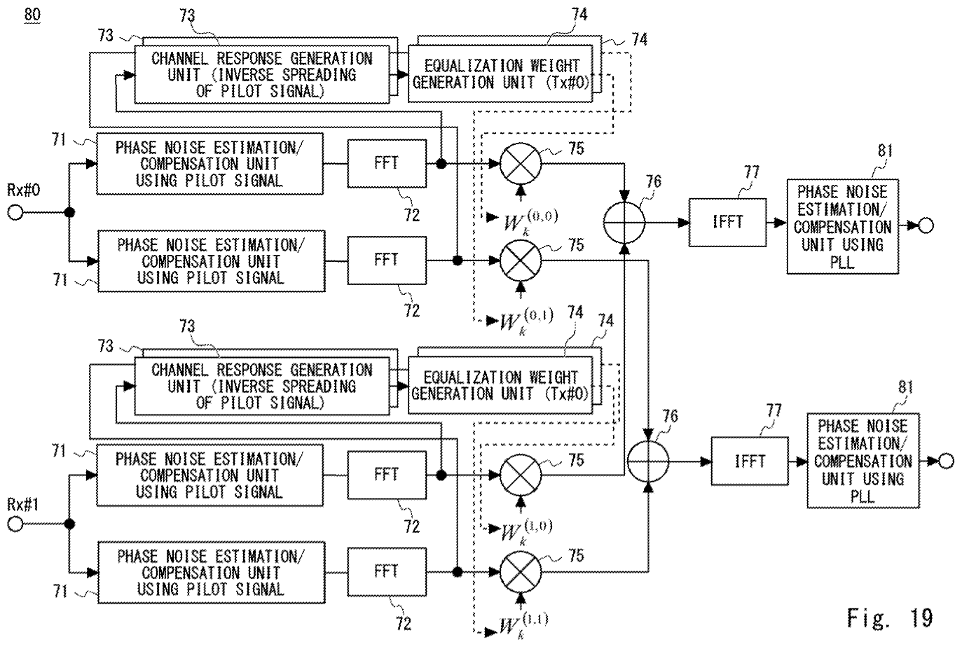

Next, a demodulation apparatus according to a fifth example embodiment will be described. The fifth example embodiment is an improved example of the demodulation apparatus described in the fourth example embodiment. A configuration of a demodulation apparatus 80 according to the fifth example embodiment will be described with reference to FIG. 19. FIG. 19 shows an example of a configuration of the demodulation apparatus according to the fifth example embodiment. The demodulation apparatus 80 according to the fifth example embodiment has a configuration that is obtained by adding a phase noise estimation/compensation unit (phase noise estimation and compensation unit) 81 using a PLL in the configuration of the demodulation apparatus 70 according to the fourth example embodiment.

The phase noise estimation/compensation unit 81 estimates a residual phase noise caused by a phase noise contained in the equalized time-domain signal, and reduces the estimated residual phase noise in the equalized time-domain signal.

Each output signal output from the demodulation apparatus 70 according to the fourth example embodiment contains residual phase noises expressed by the below-shown expressions.

Δϕ₀^{(T)}+Δϕ₀^{(R)}+Δϕ₁^{(R)} and Δϕ₁^{(T)}+Δϕ₀^{(R)}+Δϕ₁^{(R)} [Expression 8]

The phase noise estimation/compensation unit 81 estimates and compensates for residual phase variations of each of the above-described transmission signals by using a phase locked loop (PLL: Phase Locked Loop), and thereby reduces the residual phase noises.

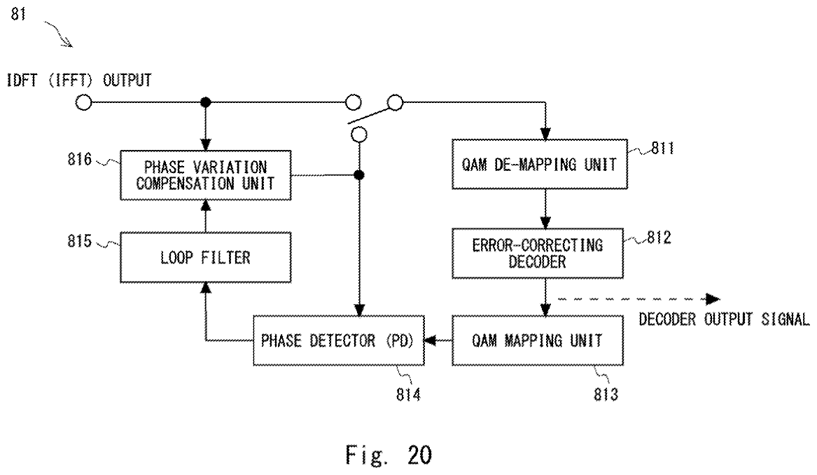

A configuration of the phase noise estimation/compensation unit 81 will be described in detail with reference to FIG. 20. FIG. 20 shows an example of a configuration of a phase noise estimation/compensation unit using a PLL. The phase noise estimation/compensation unit 81 includes a QAM de-mapping unit 811, an error-correcting decoder 812, a QAM mapping unit 813, a phase detector (PD: Phase Detector) 814, a loop filter 815, and a phase variation compensation unit 816. The QAM de-mapping unit 811 estimates an LLR of each bit of an information symbol that has been subjected to an inverse discrete Fourier transform.

The error-correcting decoder 812 inputs (i.e., supplies) the LLR of each bit to the error-correcting decoder and thereby performs error-correcting decoding.

The QAM mapping unit 813 makes a hard decision on the LLRs output by the error-correcting decoder 812, and thereby maps them onto symbols.

The PD 814 detects a phase difference between the signal which has been compensated for phase variation caused by the phase noise for the information symbol of interest and the information symbol output from the QAM mapping unit 813.

The loop filter 815 generates an estimated value of a phase variation by averaging phase differences.

The phase variation compensation unit 816 compensates for the phase variation caused by the phase noise for the information symbol of interest, and outputs the signal which has been compensated for the phase variation.

### Sixth Example Embodiment

Next, a demodulation apparatus according to a sixth example embodiment will be described.

In a receiver (demodulation apparatus) using an FDE, both pilot blocks and information symbol blocks are transformed into frequency-domain signals through a discrete Fourier transform or a fast Fourier transform. In the following description, indices of blocks are omitted. Further, the following description will be given on the assumption that pilot blocks and information symbol blocks are transformed into frequency-domain signals through a discrete Fourier transform.

A reception signal composed of blocks that has been subjected to multi-path fading is expressed by the below-shown Expression (3).

[Expression 9]

r(n)=(x(n)⊗h(n))e^{jϕ(n)}+ξ(n) (3)

In the Expression (3): x(n) represents a pilot signal or an information symbol sequence; h(n) represents a channel impulse response; φ(n) represents a phase variation caused by a phase noise; and ξ(n) represents a noise component.

The subcarriers (frequency components) k (k=0, 1, . . . , N_{DFT}−1) which have been subjected to the discrete Fourier transform are shown by the below-shown Expression (4).

$$\begin{matrix}[ Expression 10 ] & \\ {R}_{k} = {X}_{k} {H}_{k} {J}_{0} + {\sum }_{{l = 0}_{l \neq k}}^{{N}_{DFT} - 1} {X}_{l} {H}_{l} I ( k - l ) + {η}_{k} & ( 4 )\end{matrix}$$

In the Expression (4), Xₖ, Hₖ and η represent a symbol, a channel response, and a noise component in a subcarrier 1. Jᵢ represents a frequency-domain signal which is obtained by performing a discrete Fourier transform on a phase noise signal e^{jφ(n)} in the time domain, i.e., represents a DFT coefficient. Further, i is a subcarrier index, and expressed as i=−N_{DFT}/2, . . . , (N_{DFT}/2)−1.

$$\begin{matrix}[ Expression 11 ] & \\ {J}_{i} = \frac{1}{{N}_{DFT}} {\sum }_{n = 0}^{{N}_{DFT} - 1} {e}^{- j 2 π ni / {N}_{DFT}} {e}^{j ϕ ( n )} & ( 5 )\end{matrix}$$

In the Expression (5), the zero-frequency component J₀ is expressed by the below-shown Expression (6).

$$\begin{matrix}[ Expression 12 ] & \\ {J}_{0} = \frac{1}{{N}_{DFT}} {e}^{j {Φ}_{0}} {\sum }_{n = 0}^{{N}_{DFT} - 1} {e}^{j Δϕ ( n )} \approx {e}^{j {Φ}_{0}} & ( 6 )\end{matrix}$$

In the Expression (6), Φ₀ represents an average phase deviation between blocks, and Δφ(n) represents a phase deviation from Φ₀ at each sample point.

Since Δφ(n) has a very small value, the approximation expressed by the Expression (6) holds. The zero-frequency component J₀ is a common phase rotation at all the subcarrier positions and therefore is called a CPE (Common Phase Error), and it can be easily estimated. The second term on the right side of the Expression (4) is inter-subcarrier interference (ICI: Inter-subcarrier interference) which changes according to the subcarrier position. As shown in the Expression (4), the phase variations caused by phase noises in the time domain become inter-subcarrier interference caused in a plurality of subcarriers adjacent to each other in the frequency domain. Therefore, in the demodulation apparatus according to this example embodiment, for the reception signal in the frequency domain, a CPE is estimated and compensated for. Then frequency-domain equalization is performed thereon.

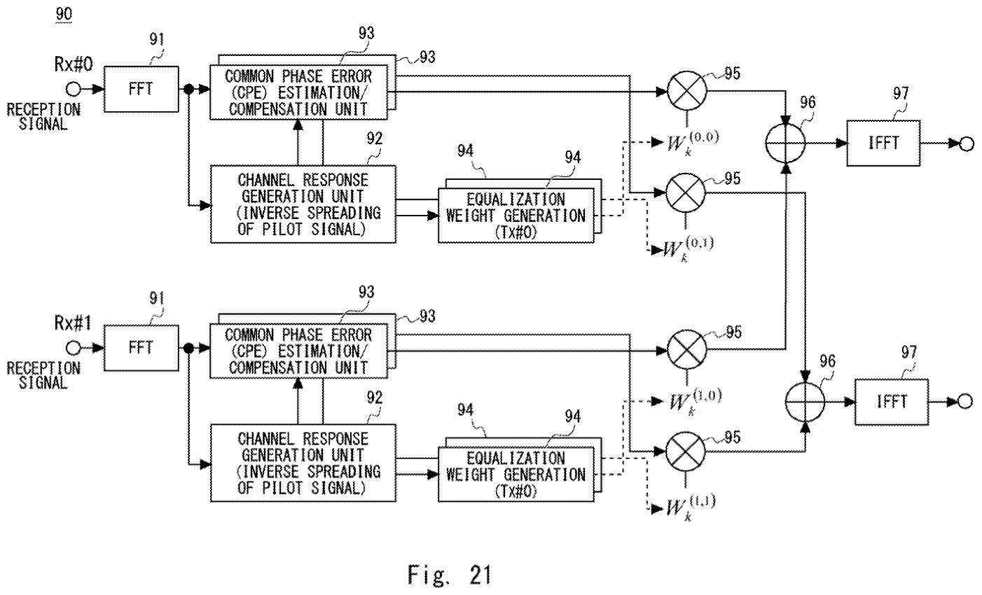

An example of a configuration of a demodulation apparatus 90 according to the sixth example embodiment will be described with reference to FIG. 21. FIG. 21 shows the example of the configuration of the demodulation apparatus 90 according to the sixth example embodiment. The demodulation apparatus 90 includes a transformation unit 91, a channel response generation unit 92, a common phase error estimation/compensation unit (common phase error estimation and compensation unit) 93, an equalization weight generation unit 94, an equalization weight multiplication unit 95, an addition unit 96, and an inverse transformation unit 97.

The demodulation apparatus 90 estimates and compensates for a CPE for a reception signal in the frequency domain, and then performs frequency-domain equalization. Note that, in the Expression (4), the demodulation apparatus 90 ignores the removal of higher-order inter-subcarrier interference Jᵢ (i=−N_{DFT}/2, . . . , (N_{DFT}/2)−1) because the higher-order inter-subcarrier interference Jᵢ is small compared to the zero-frequency component J₀.

The transformation unit 91 transforms the reception signal into a frequency-domain signal through a discrete Fourier transform. Note that the transformation unit 91 may transform the reception signal into a frequency-domain signal through a fast Fourier transform.

The channel response generation unit 92 calculates a channel response at each subcarrier position by performing inverse spreading on a pilot signal in the frequency domain.

The common phase error estimation/compensation unit 93 estimates common phase variations in all frequency components (subcarriers) over the transmission signal band based on the channel response at each subcarrier position. The common phase error estimation/compensation unit 93 compensates for the phase variation by multiplying the reception signal by a phase variation opposite to the estimated phase variation.

The common phase error estimation/compensation unit 93 estimates a CPE by using pilot symbols of the pilot signal block according to the below-shown Expression (7).

$$\begin{matrix}[ Expression 13 ] & \\ {\tilde{J}}_{0} = \frac{{\sum }_{k = 0}^{{N}_{DFT} - 1} {R}_{plt} ( k ) {X}_{plt}^{*} ( k ) {H}_{plt}^{*} ( k )}{{\sum }_{k = 0}^{{N}_{DFT} - 1} {\vert {X}_{plt} ( k ) {H}_{plt} ( k ) \vert}^{2}} & ( 7 )\end{matrix}$$

In the Expression (7), Xₚₗₜ (k) and Rₚₗₜ (k) are a complex signal of the pilot symbol and a frequency-domain signal of the reception signal, respectively.

The common phase error estimation/compensation unit 93 compensates for the estimated CPE represented by

\tilde{J}₀ [Expression 14]

by multiplying the reception signal by a complex conjugate of the CPE.

The equalization weight generation unit 94 generates an equalization weight of a minimum mean square error (MMSE: Minimum Mean Square Error) criterion from the estimated channel response.

The equalization weight multiplication unit 95 performs frequency-domain equalization by multiplying each subcarrier signal of the reception signal by the equalization weight.

The addition unit 96 performs diversity synthesis by adding, in an in-phase manner, the signals which have been transmitted by the same transmission antenna, received by the two antennas, and subjected the frequency-domain equalization.

The inverse transformation unit 97 transforms the diversity-synthesized signal into a time-domain signal through an inverse discrete Fourier transform. Note that the inverse transformation unit 97 may transform the diversity-synthesized signal into a time-domain signal through an inverse fast Fourier transform.

### Modified Example

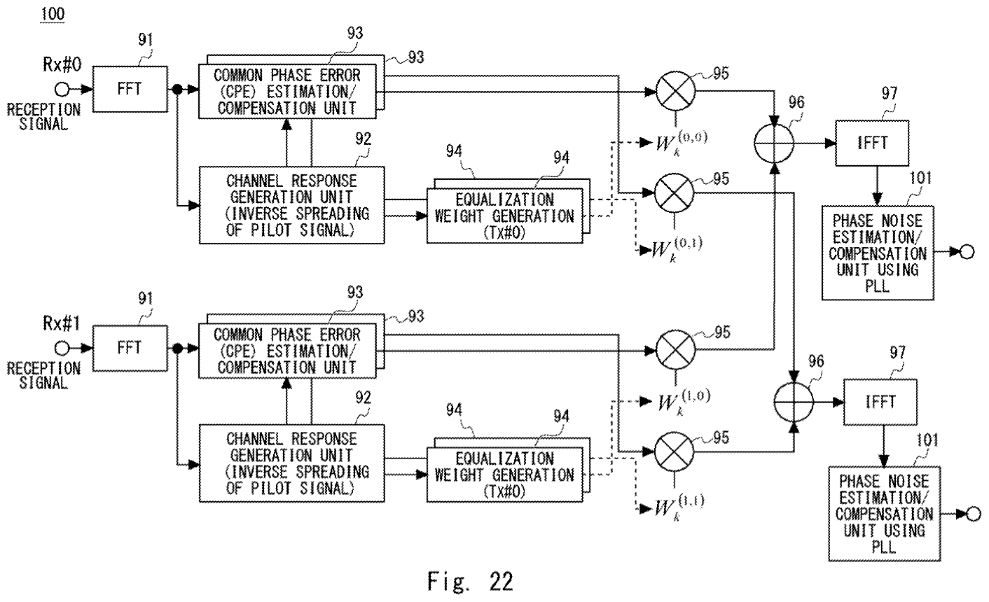

The demodulation apparatus 90 according to the sixth example embodiment may be configured so as to estimate a phase variation caused by a residual phase noise by using a phase locked loop PLL, and compensate for the estimated phase variation. FIG. 22 shows an example of a configuration of a demodulation apparatus according to a modified example of the sixth example embodiment.

The demodulation apparatus 100 includes a phase noise estimation/compensation unit (phase noise estimation and compensation unit) 101 in addition to the configuration of the demodulation apparatus 90 according to the sixth example embodiment.

The phase noise estimation/compensation unit 101 has the configuration shown in FIG. 20, and estimates a phase variation caused by a residual phase noise by using the PLL shown in FIG. 20, and compensates for the estimated phase variation.

### Seventh Example Embodiment

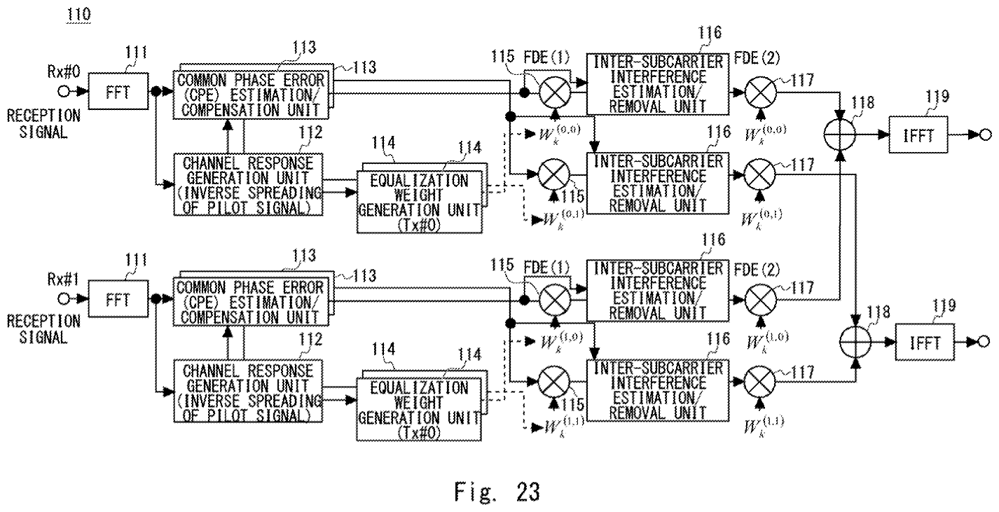

Next, a demodulation apparatus 110 according to a seventh example embodiment will be described. FIG. 23 shows an example of the demodulation apparatus 110 according to the seventh example embodiment. The demodulation apparatus 110 includes a transformation unit 111, a channel response generation unit 112, a common phase error estimation/compensation unit (common phase error estimation and compensation unit) 113, an equalization weight generation unit 114, an equalization weight multiplication unit 115, an inter-subcarrier interference estimation/removal unit 116, an equalization weight multiplication unit 117, an addition unit 118, and an inverse transformation unit 119.

The demodulation apparatus 110 estimates and compensates for a CPE for a reception signal in the frequency domain, and then estimates and removes inter-subcarrier interference expressed by the Expression (5) by performing frequency-domain equalization.

The transformation unit 111 transforms the reception signal into a frequency-domain signal through a discrete Fourier transform. Note that the transformation unit 111 may transform the reception signal into a frequency-domain signal through a fast Fourier transform.

The channel response generation unit 112 calculates a channel response at each subcarrier position by performing inverse spreading on a pilot signal in the frequency domain.

The common phase error estimation/compensation unit 113 estimates a CPE J₀ by using pilot symbols of the pilot signal block as in the case of the demodulation apparatus 90 according to the sixth example embodiment, and compensates for the CPE represented by

\tilde{J}₀ [Expression 15]

by multiplying the reception signal by a complex conjugate of the CPE.

The equalization weight generation unit 114 generates an equalization weight of a minimum mean square error (MMSE: Minimum Mean Square Error) criterion from the estimated value of the channel response.

The equalization weight multiplication unit 115 performs frequency-domain equalization by multiplying each subcarrier signal of the reception signal by the generated equalization weight.

The inter-subcarrier interference estimation/removal unit 116 estimates inter-subcarrier interference at each subcarrier position of the reception signal and compensates for the estimated inter-subcarrier interference.

Here, a subset l={0, 1, . . . , N−1} is defined by L={l₁, l₂, . . . , lₖ}. A reception signal in the frequency domain for the subset L of the subcarrier is expressed by the below-shown expression (^{T} represents a transposition).

R=[Rₗ_{₁},Rₗ_{₂},Rₗ_{₃}, . . . ,Rₗ_{ₖ}]^{T} [Expression 16]

R is expressed by the below-shown expression.

$$\begin{matrix} [ Expression 17 ] & \\ [ \begin{matrix}{R}_{{l}_{1}} \\ {R}_{{l}_{2}} \\ ⋯ \\ {R}_{{l}_{k}}\end{matrix} ] = \underbrace{[ \begin{matrix}{H}_{{l}_{1}} {X}_{{l}_{1}} & {H}_{{l}_{1} - 1} {X}_{{l}_{1} - 1} & {H}_{{l}_{1} + 1} {X}_{{l}_{1} + 1} & ⋯ & {H}_{{l}_{1} + li} {X}_{{l}_{1} + li} \\ {H}_{{l}_{2}} {X}_{{l}_{2}} & {H}_{{l}_{2} - 1} {X}_{{l}_{2} - 1} & {H}_{{l}_{2} + 1} {X}_{{l}_{2} + 1} & ⋯ & {H}_{{l}_{2} + li} {X}_{{l}_{2} + li} \\ ⋯ & ⋯ & ⋯ & ⋯ & ⋯ \\ {H}_{{l}_{k}} {X}_{{l}_{k}} & {H}_{{l}_{k} - 1} {X}_{{l}_{k} - 1} & {H}_{{l}_{k} + 1} {X}_{{l}_{k} + 1} & ⋯ & {H}_{{l}_{k} + li} {X}_{{l}_{k} + li}\end{matrix} ]}_{A} \underbrace{[ \begin{matrix}{J}_{0} \\ {J}_{1} \\ {J}_{- 1} \\ ⋯ \\ {J}_{u} \\ {J}_{- u}\end{matrix} ]}_{J} + \underbrace{[ \begin{matrix}{Ϛ}_{ICI , {I}_{1}}^{′} \\ {Ϛ}_{ICI , {I}_{2}}^{′} \\ {Ϛ}_{ICI , {I}_{3}}^{′} \\ ⋯ \\ {Ϛ}_{ICI , {I}_{k - 1}}^{′} \\ {Ϛ}_{ICI , {I}_{k}}^{′}\end{matrix} ]}_{{Ϛ}_{ICI}^{′}} + \underbrace{[ \begin{matrix}{η}_{{I}_{1}} \\ {η}_{{I}_{2}} \\ {η}_{{I}_{3}} \\ ⋯ \\ {η}_{{I}_{k - 1}} \\ {η}_{{I}_{k}}\end{matrix} ]}_{η} & ( 8 )\end{matrix}$$

In the Expression (8), J=DFT{e^{jφ(n)}} is a frequency spectrum component resulting from a phase noise, and ζ′_{ICI} is a residual ICI component expressed in the form of a vector.

Frequency spectrum components Jᵢ(i=−u, . . . , u) resulting from phase noises are estimated. When k is defined as k=2u+1 and the Expression (8) is expressed in the form of a vector, the below-shown expression is obtained.

[Expression 18]

R=AJ+ζ′_{ICI}+η (9)

By using a minimum mean square error (MMSE. Minimum Mean Square Error) algorithm, from the Expression (9), the estimated value of J is represented by

\tilde{J} [Expression 19]

is obtained by the below-shown Expression.

[Expression 20]

\tilde{J}=MR (10)

In the Expression (10), M is expressed by the below-shown expression.

$$\begin{matrix}[ Expression 21 ] & \\ M = \frac{{R}_{JJ} {A}^{H}}{{AR}_{JJ} {A}^{H} + {R}_{ɛɛ}} & ( 11 )\end{matrix}$$

In the Expression (11), F is expressed as ε=ζ′_{ICI}+η, Rⱼⱼ and R_{εε} are correlation matrixes of j and ε, respectively.

R_{J}_{ₘ}_{J}_{ₘ} and R_{ε}_{ₘ}_{ε}_{ₘ} [Expression 22]

can be estimated by using pilot signals, or can be obtained by a decision feedback process by using information symbols of an FFT block before the FFT block of interest.

The matrix A in the Expression (11) is composed of demodulated symbols X₁. A frequency-domain equalized complex signal is used for X₁. R_{N} is expressed as

R_{N}=[R_{-N/2}, . . . ,R_{(N/2)-1}]^{T} [Expression 23]

and the frequency-domain signal which has been compensated for the phase variations caused by the phase noises can be calculated by a convolution process of R_{N} and U as expressed by the below-shown expression.

[Expression 24]

\tilde{R}_{N}=R_{N}⊗Ũ (12)

In the Expression (12), the below-shown expression holds.

Ũᵢ=DFT{e^{-jϕ(n)}}=J*₋ᵢ [Expression 25]

However, the value of i is only in a rage of values of i=−u, . . . , u in the vicinity of the subcarrier of interest, and the value of Jᵢ for |i|>u is set to zero because the inter-subcarrier interference caused by them is small.

The inter-subcarrier interference estimation/removal unit 116 calculates a frequency-domain signal from which the inter-subcarrier interference caused by phase noises has been removed by using the Expression (12). In other words, the inter-subcarrier interference estimation/removal unit 116 calculates a coefficient(s) of a discrete Fourier transform for the phase noises based on the reception signal at each subcarrier position of the information symbol block, the estimated value of the channel response at each subcarrier position, and the equalized signal at each subcarrier position. Further, the inter-subcarrier interference estimation/removal unit 116 estimates inter-subcarrier interference at each subcarrier position from the estimated value of the channel response at each subcarrier position, the equalized signal at each subcarrier position, and the coefficient(s) of the discrete Fourier transform for the phase noises, and compensates for the estimated inter-subcarrier interference.

The equalization weight multiplication unit 117 performs, by using the MMSE equalization weight, frequency-domain equalization on the signal from which the inter-subcarrier interference caused by the phase noises has been removed.

The addition unit 118 performs diversity synthesis by adding, in an in-phase manner, the signals which have been transmitted by the same transmission antenna, received by the two antennas, and subjected the frequency-domain equalization.

The inverse transformation unit 119 transforms the diversity-synthesized signal into a time-domain signal through an inverse discrete Fourier transform. Note that the inverse transformation unit 119 may transform the diversity-synthesized signal into a time-domain signal through an inverse fast Fourier transform.

### Eighth Example Embodiment

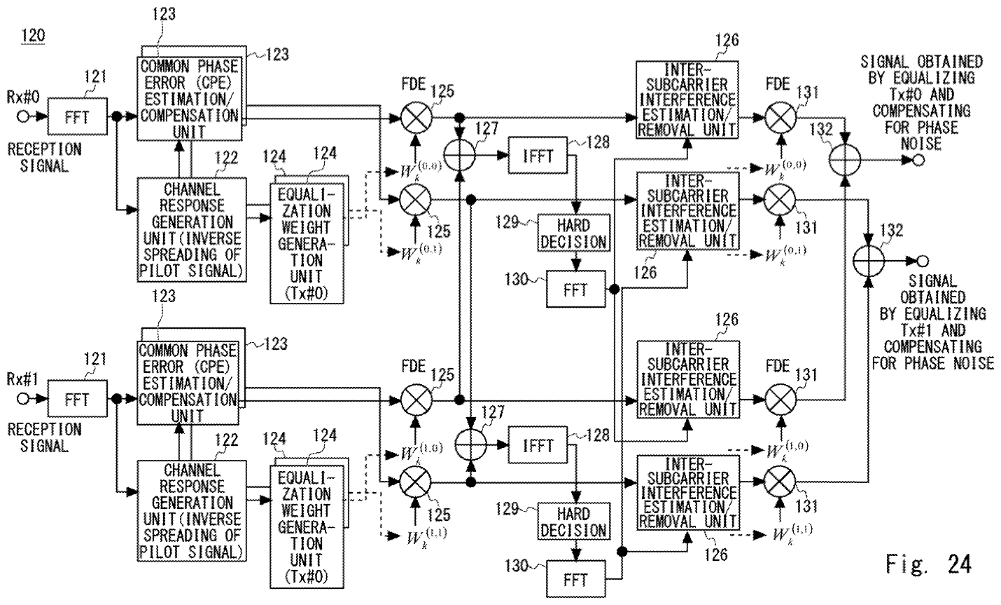

Next, a demodulation apparatus 120 according to an eighth example embodiment will be described. FIG. 24 shows an example of a configuration of the demodulation apparatus according to the eighth example embodiment. The demodulation apparatus 120 includes a transformation unit 121, a channel response generation unit 122, a common phase error estimation/compensation unit (common phase error estimation and compensation unit) 123, an equalization weight generation unit 124, an equalization weight multiplication unit 125, an inter-subcarrier interference estimation/removal unit (inter-subcarrier interference estimation and removal unit) 126, an addition unit 127, and an inverse transformation unit 128. The demodulation apparatus 120 further includes a hard decision unit 129, a transformation unit 130, an equalization weight multiplication unit 131 and an addition unit 132.

The transformation unit 121, the channel response generation unit 122, and the common phase error estimation/compensation unit 123 correspond to the transformation unit 111, the channel response generation unit 112, and the common phase error estimation/compensation unit 113 according to the seventh example embodiment, and have configurations similar to those of them. The equalization weight generation unit 124 and the equalization weight multiplication unit 125 correspond to the equalization weight generation unit 114 and the equalization weight multiplication unit 115 according to the seventh example embodiment, and have configurations similar to those of them. Therefore, in the following description, parts of the explanations of the above-described configurations which are similar to those in the seventh example embodiment are omitted as appropriate.

Similarly to the demodulation apparatus 110 according to the seventh example embodiment, the demodulation apparatus 120 estimates and compensates for a CPE for a reception signal in the frequency domain, and then estimates and removes inter-subcarrier interference expressed by the Expression (5). In this example embodiment, hard-decision symbols for which the inverse discrete Fourier transform process performed by the inverse-transform unit 128 has already been performed is used for X₁ in the above-shown Expression (11).

The addition unit 127 performs diversity synthesis by adding, in an in-phase manner, the signals which have been transmitted by the same transmission antenna, received by the two antennas, and subjected the frequency-domain equalization.

The inverse transformation unit 128 transforms the signal which has been diversity-synthesized in the addition unit 127 into a signal in the time domain by performing an inverse discrete Fourier transform thereon, and outputs the transformed signal to the hard decision unit 129.

The hard decision unit 129 performs a hard decision on the signal output from the inverse transformation unit 128 on a symbol-by-symbol basis, and outputs hard-decision symbols as a result of the hard decision.

The transformation unit 130 transforms the hard-decision symbols into subcarrier signals in the frequency domain by performing a discrete Fourier transform thereon. Note that the transformation unit 130 may transform the symbols into subcarrier signals in the frequency domain by performing a fast Fourier transform.

The inter-subcarrier interference estimation/removal unit 126 obtains DFT coefficients Jᵢ(i=−u, . . . , u) of phase noises by using the hard decision symbols. Similarly to the seventh example embodiment, the inter-subcarrier interference estimation/removal unit 126 calculates the below-shown expression,

Ũᵢ=DFT{e^{-jϕ(n)}}=J*₋ᵢ [Expression 26]

and obtains a phase noise suppressed signal by using the Expression (12). The inter-subcarrier interference estimation/removal unit 126 outputs the signal from which the inter-subcarrier interference caused by phase noises has been removed to the equalization weight multiplication unit 131.

The equalization weight multiplication unit 131 performs, by using the MMSE equalization weight, frequency-domain equalization on the signal from which the inter-subcarrier interference caused by the phase noises has been removed.

The addition unit 132 performs diversity synthesis by adding, in an in-phase manner, the signals which have been transmitted by the same transmission antenna, received by the two antennas, and subjected the frequency-domain equalization.

Since the demodulation apparatus 120 performs a decision feedback process by using hard-decision symbols, the hard decision symbols can also be referred to as decision feedback symbols. Therefore, the inter-subcarrier interference estimation/removal unit 126 operates to obtain a coefficient(s) of a discrete Fourier transform for the phase noises from the reception signal at each subcarrier position of the information symbol block, the estimated value of the channel response at each subcarrier position, and the equalized signal at each subcarrier position. Further, the inter-subcarrier interference estimation/removal unit 126 operates to estimate and compensate for inter-subcarrier interference at each subcarrier position by using the estimated value of the channel response at each subcarrier position, the coefficient(s) of the discrete Fourier transform for the phase noises, and the decision feedback information symbols, and compensates for the estimated inter-subcarrier interference.

Note that, in this example embodiment, although inter-subcarrier interference is estimated by using decision feedback symbols, a delay time caused by the decision feedback process is very short. Therefore, the effect for the processing delay is small.

### Modified Example

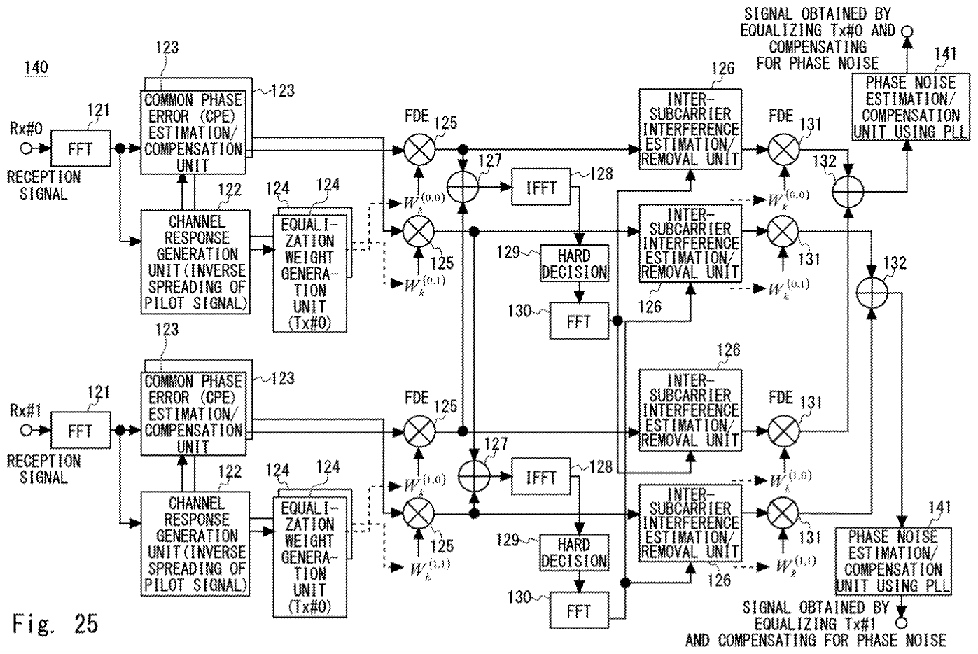

The demodulation apparatus 120 according to the eighth example embodiment may be configured so as to estimate a phase variation caused by a residual phase noise by using a phase locked loop PLL, and compensate for the estimated phase variation. FIG. 25 shows an example of a configuration of a demodulation apparatus according to a modified example of the eighth example embodiment.

The demodulation apparatus 140 includes a phase noise estimation/compensation unit (phase noise estimation and compensation unit) 141 in addition to the configuration of the demodulation apparatus 120 according to the eighth example embodiment.

The phase noise estimation/compensation unit 141 has the configuration shown in FIG. 20, and estimates a phase variation caused by a residual phase noise by using the PLL shown in FIG. 20, and compensates for the estimated phase variation.

The demodulation apparatus 140 repeatedly performs a process of estimating inter-subcarrier interference at each subcarrier position by using the estimated value of the channel response at each subcarrier position, the coefficient(s) of the discrete Fourier transform for the phase noises, and the decision feedback symbols, and compensating for the estimated inter-subcarrier interference. Further, the demodulation apparatus 140 repeatedly performs a process of estimating and compensating for a residual phase variation by using a phase locked loop (PLL). Therefore, according to the demodulation apparatus 140, it is possible to reduce residual phase noises to a very low level.

### Ninth Example Embodiment

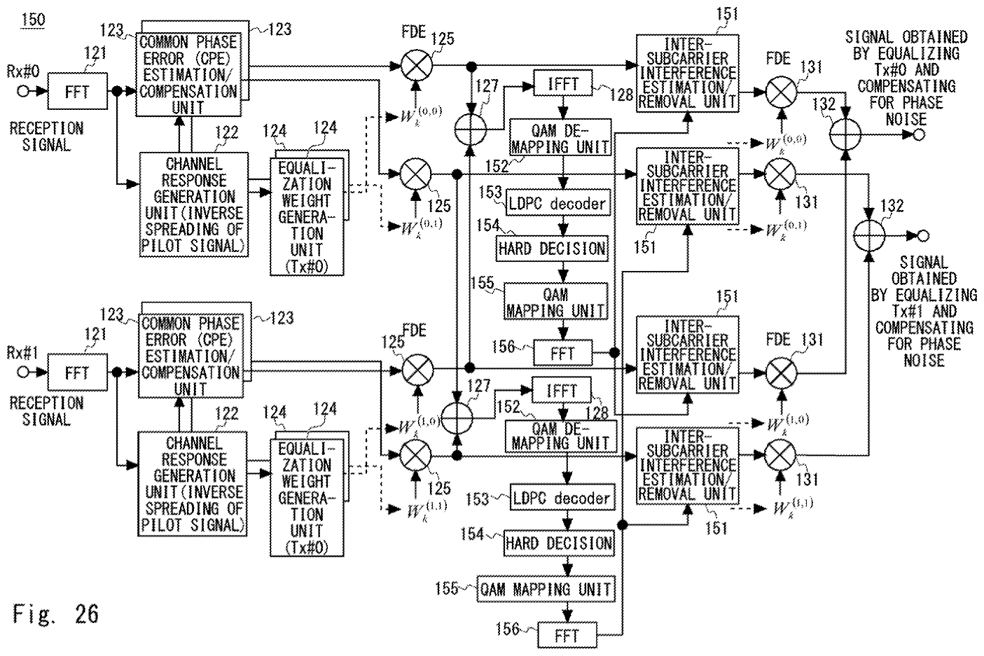

Next, a demodulation apparatus 150 according to a ninth example embodiment will be described. FIG. 26 shows an example of a configuration of a demodulation apparatus according to the ninth example embodiment. The demodulation apparatus 150 has a configuration that is obtained by replacing the inter-subcarrier interference estimation/removal unit 126 and the hard decision unit 129 according to the eighth example embodiment by an inter-subcarrier interference estimation/removal unit 151 and a hard decision unit 154, respectively. Further, the demodulation apparatus 150 includes, in addition to the configuration of the demodulation apparatus 120 according to the eighth example embodiment, a QAM de-mapping unit 152, an error-correcting decoder 153, a hard decision unit 154, a QAM mapping unit 155, and a transformation unit 156. In the following description, parts of the explanations of the configuration that are the same as those of the demodulation apparatus 120 according to the eighth example embodiment are omitted as appropriate.

The demodulation apparatus 150 estimates and compensates for a CPE for a reception signal in the frequency domain, and then estimates and removes inter-subcarrier interference expressed by the Expression (5). Further, the demodulation apparatus 150 uses information symbols that are generated by symbol-mapping error-correcting decoded bits onto X₁ in the Expression (11).

The QAM de-mapping unit 152 calculates a log likelihood ratio (LLR) of each bit of each information symbol for which the inverse discrete Fourier transform process has already been performed, and inputs (i.e., supplies) the calculated LLR to the error-correcting decoder 153.

The error-correcting decoder 153 is, for example, a low-density parity check code (LDPC: Low-Density Parity Check codes) decoder, and performs an error-correcting decoding process for the input LLR.

The hard decision unit 154 performs a hard decision on reliable decoded bits output from the error-correcting decoder.

The QAM mapping unit 155 generates information symbols by symbol-mapping reliable decoded bits output from the error-correcting decoder. Since the demodulation apparatus 150 also performs a decision feedback process by using information symbols, the information symbols can also be referred to as decision feedback information symbols.

The transform unit 156 transforms the generated information symbol block into a subcarrier signal in the frequency-domain through a discrete Fourier transform, and outputs the transformed subcarrier signal to the inter-subcarrier interference estimation/removal unit 151. Note that the transformation unit 156 may transform the information symbol block into a subcarrier signal in the frequency-domain through a fast Fourier transform.

The inter-subcarrier interference estimation/removal unit 151 obtains DFT coefficients Jᵢ (i=−u, . . . , u) of phase noises by using the subcarrier signal in the frequency domain output from the transformation unit 156 for X₁ in the Expression (11). Similarly to the seventh and eighth example embodiments, the inter-subcarrier interference estimation/removal unit 151 calculates the below-shown expression,

Ũᵢ=DFT{e^{-jϕ(n)}}=J*₋ᵢ [Expression 27]

and obtains a phase-noise suppressed signal by using the Expression (12). The inter-subcarrier interference estimation/removal unit 151 outputs the signal from which the inter-subcarrier interference caused by phase noises has been removed to the equalization weight multiplication unit 131.

The equalization weight multiplication unit 131 performs, by using the MMSE equalization weight, frequency-domain equalization on the signal from which the inter-subcarrier interference caused by the phase noises has been removed.

The demodulation apparatus 150 according to this example embodiment generates inter-subcarrier interference caused by the phase noises by using reliable decoded bits for which the error-correcting decoding has already been performed. Since the error-correcting decoded bits are used, the processing delay is larger than that of the demodulation apparatus 120 according to the eighth example embodiment. Therefore, it may be configured so that the processing of the demodulation apparatus 150 according to this example embodiment is performed after the processing of the demodulation apparatus 120 according to the eighth example embodiment is performed.

Although the present invention is explained above with reference to example embodiments, the present invention is not limited to the above-described example embodiments. Various modifications that can be understood by those skilled in the art can be made to the configuration and details of the present invention within the scope of the invention. Further, the present disclosure may also be implemented by combining the example embodiments with one another as appropriate.

Further, the whole or part of the example embodiments disclosed above can be described as, but not limited to, the following supplementary notes.

(Supplementary Note 1)

A modulation apparatus used in a line of sight multiple input multiple output (LOS-MIMO: Line Of Sight-Multiple Input Multiple Output) radio communication system, comprising:

means for transforming a time-domain pilot signal sequence into a first number of frequency-domain signals corresponding to a sequence length of the pilot signal sequence;

means for mapping the first number of frequency-domain signals at the same number of subcarrier intervals as a number of transmitting antennas of the modulation apparatus by shifting mapping positions of heads of the frequency-domain signals one after another by an amount equivalent to one subcarrier so that the frequency-domain signals do not overlap each other;

means for transforming the mapped frequency-domain signals into time-domain signals; and

means for setting the time-domain signals in a pilot block.

(Supplementary Note 2)

A modulation apparatus used in a line of sight multiple input multiple output (LOS-MIMO: Line Of Sight-Multiple Input Multiple Output) radio communication system, comprising:

means for generating a spread code of a sequence length of a time-domain pilot signal sequence and generating a second number of cyclic shift sequences by cyclically shifting the generated spread code;

means for transforming the second number of pilot signals into a third number of frequency-domain signals corresponding to the sequence length;

means for mapping the third number of frequency-domain signals onto a fifth number of frequency components at a fourth number of subcarrier intervals by shifting mapping positions of heads of the frequency-domain signals one after another by an amount equivalent to one subcarrier so that the frequency-domain signals do not overlap each other, the fourth number being a number based on the number of transmitting antennas of the modulation apparatus and the second number, and the fifth number being a number based on the sequence length and the fourth number;

means for transforming the mapped frequency-domain signals into time-domain signals; and

means for setting the time-domain signals in a pilot block.

(Supplementary Note 3)

The modulation apparatus described in Supplementary note 1 or 2, further comprising:

means for receiving a message for controlling transmission power of the pilot signal from a demodulation apparatus according to whether or not an error rate measured by the demodulation apparatus meets a target error rate; and

means for controlling the transmission power according to the message.

(Supplementary Note 4)

A demodulation apparatus used in a line of sight multiple input multiple output (LOS-MIMO: Line Of Sight-Multiple Input Multiple Output) radio communication system, comprising:

means for transforming a pilot signal contained in a reception signal into a frequency-domain signal;

means for shifting a position of a first subcarrier from the frequency-domain signal, and extracting the same number of subcarrier signals as the number of receiving antennas of the demodulation apparatus at the same number of subcarrier intervals as the number of receiving antennas thereof;

means for generating a channel response by multiplying each of the same number of subcarrier signals as the number of receiving antennas by a complex conjugate of a frequency-domain sequence of the pilot signal;

means for averaging, for each of the same number of subcarrier signals as the number of receiving antennas, channel responses of a plurality of subcarrier signals spaced apart from one another at the same number of subcarrier intervals as the number of receiving antennas; and

means for interpolating, based on the averaged channel response of each of the same number of subcarrier signals as the number of receiving antennas, a channel response of a signal in which each information symbol contained in the reception signal is set.

(Supplementary Note 5)

A demodulation apparatus used in a line of sight multiple input multiple output (LOS-MIMO: Line Of Sight-Multiple Input Multiple Output) radio communication system, comprising:

means for transforming a pilot signal contained in a reception signal into a frequency-domain signal;

means for shifting a position of a first subcarrier from the frequency-domain signal, and extracting a first number of subcarrier signals at the first number of subcarrier intervals, the first number being a number based on the number of receiving antennas of the demodulation apparatus and the number of cyclic shifts of the pilot signal;

means for generating a channel response by multiplying each of the first number of extracted subcarrier signals by a complex conjugate of a frequency-domain sequence corresponding to the number of cyclic shifts, and adding, in an in-phase manner, a plurality of subcarrier signals spaced apart from one another at the first number of subcarrier intervals;

means for averaging, for each of the same number of subcarrier signals as the number of receiving antennas, channel responses of a plurality of subcarrier signals spaced apart from one another at the same number of subcarrier intervals as the number of receiving antennas; and

means for interpolating, based on the averaged channel response of each of the same number of subcarrier signals as the number of receiving antennas, a channel response of a signal in which each information symbol contained in the reception signal is set.

(Supplementary Note 6)

A demodulation apparatus used in a line of sight multiple input multiple output (LOS-MIMO: Line Of Sight-Multiple Input Multiple Output) radio communication system, comprising:

means for estimating, by using a pilot signal contained in a reception signal, a first channel response of a transmission signal transmitted from each of a plurality of transmitting antennas provided in another radio communication apparatus;

means for estimating, based on the estimated first channel response, a phase variation at a pilot block position at which the pilot signal is set;

means for, based on the phase variation at the pilot block position, interpolating and compensating for the phase variation at a block position at which an information symbol included between adjacent pilot block positions is set;

means for transforming the reception signal which has been compensated for the phase variation into a frequency-domain signal;

means for estimating, by using the pilot signal contained in the frequency-domain signal, a second channel response indicating a channel response, at each of a plurality of subcarrier positions, to a transmission signal transmitted from each of the plurality of transmission antennas;

means for generating an equalization weight based on the estimated second channel response, and equalizing the frequency-domain signal by multiplying an information symbol at each of the plurality of subcarrier positions by the equalization weight; and

means for transforming the equalized frequency-domain signal into a time-domain signal.

(Supplementary Note 7)

A demodulation apparatus used in a line of sight multiple input multiple output (LOS-MIMO: Line Of Sight-Multiple Input Multiple Output) radio communication system, comprising:

means for transforming a time-domain reception signal into a frequency-domain signal;

means for estimating, by using a pilot signal contained in the transformed frequency-domain signal, a channel response, at each of a plurality of subcarrier positions, to a transmission signal transmitted from each of a plurality of transmission antennas provided in another radio communication apparatus;

means for estimating, based on the estimated channel response, a common phase variation common to all the subcarrier positions, and compensating for the estimated common phase variation from the transformed frequency-domain signal;

means for generating an equalization weight based on the estimated channel response, and equalizing the frequency-domain signal by multiplying an information symbol at each of the plurality of subcarrier positions at which the common phase variation has been compensated for by the equalization weight; and

means for transforming the equalized frequency-domain signal into a time-domain signal.

(Supplementary Note 8)

The demodulation apparatus described in Supplementary note 7, further comprising means for estimating inter-subcarrier interference at each of the plurality of subcarrier positions, and compensating for the estimated inter-subcarrier interference.

(Supplementary Note 9)

The demodulation apparatus described in Supplementary note 8, further comprising means for equalizing the frequency-domain signal which has been compensated for the inter-subcarrier interference by multiplying the frequency-domain signal which has been compensated for the inter-subcarrier interference by the equalization weight, wherein

the compensation means estimates inter-subcarrier interference at each of the plurality of subcarrier positions based on the frequency-domain signal at each of the plurality of subcarrier positions, the estimated channel response, and the multiplied frequency-domain signal at each of the plurality of subcarrier positions, and compensates the estimated inter-subcarrier interference, and

the means for transformation transforms the frequency-domain signal which has been obtained by equalizing the frequency-domain signal which has been compensated for the inter-subcarrier interference into a time-domain signal.

(Supplementary Note 10)

The demodulation apparatus described in Supplementary note 8, wherein the means for compensation estimates inter-subcarrier interference at each of the plurality of subcarrier positions based on the frequency-domain signal at each of the plurality of subcarrier positions, the estimated channel response, the multiplied frequency-domain signal at each of the plurality of subcarrier positions, and a decision feedback information symbol, and compensates for the estimated inter-subcarrier interference.

(Supplementary Note 11)

The demodulation apparatus described in Supplementary note 10, further comprising:

means for making a hard decision on the transformed time-domain signal and outputs the decision feedback information symbol; and

means for transforming the decision feedback information symbol into one in the frequency domain.

(Supplementary Note 12)

The demodulation apparatus described in Supplementary note 10, further comprising:

means for calculating a log likelihood ratio of each bit of an information symbol contained in the transformed time-domain signal;

an error-correcting decoder configured to perform error-correcting decoding on the log likelihood ratio;

means for estimating a transmission bit by making a hard decision on the error-correcting decoded log likelihood ratio;

means for generating the decision feedback information symbol by error-correcting encoding an estimated value of the transmission bit; and

means for transforming the decision feedback information symbol into one in the frequency domain.

(Supplementary Note 13)

The demodulation apparatus described in any one of Supplementary notes 6 to 12, further comprising means for estimating a residual phase variation contained in the transformed time-domain signal, and reducing the estimated residual phase variation from the transformed time-domain signal.

This application is based upon and claims the benefit of priority from Japanese patent application No. 2019-083947, filed on Apr. 25, 2019, the disclosure of which is incorporated herein in its entirety by reference.

### REFERENCE SIGNS LIST

10, 30, 50 MODULATION APPARATUS
11, 21, 33, 61, 72, 91, 111, 121, 130, 156 TRANSFORMATION UNIT
12, 34 SUBCARRIER MAPPING UNIT
13, 63, 77, 97, 119, 128 INVERSE-TRANSFORMATION UNIT
20, 60, 70, 80, 90, 100, 110, 120, 140, 150 DEMODULATION APPARATUS
22 SUBCARRIER DE-MAPPING UNIT
23, 43, 73, 92, 112, 122 CHANNEL RESPONSE GENERATION UNIT
24, 44 AVERAGING/INTERPOLATION UNIT
31 SPREADING CODE GENERATION UNIT
32, 502 CYCLIC-SHIFT GENERATION UNIT
51 BOOST UNIT
52 DA CONVERTER
62 FDE
64, 65, 816 PHASE VARIATION COMPENSATION UNIT
71, 81, 101, 141 PHASE NOISE ESTIMATION/COMPENSATION UNIT
74, 94, 114, 124 EQUALIZATION WEIGHT GENERATION UNIT
75, 95, 115, 117, 125, 131 EQUALIZATION WEIGHT MULTIPLICATION UNIT
76, 96, 118, 127, 132 ADDITION UNIT
93, 113, 123 COMMON PHASE ERROR ESTIMATION/COMPENSATION UNIT
116, 126, 151 INTER-SUBCARRIER INTERFERENCE ESTIMATION/REMOVAL UNIT
129, 154 HARD-DECISION UNIT
152, 811 QAM DE-MAPPING UNIT
153 ERROR-CORRECTING DECODER
155, 813 QAM MAPPING UNIT
500 TRANSMITTER
501 SPREADING SEQUENCE GENERATION UNIT
600 RECEIVER
812 ERROR CORRECTION DECODER
814 PHASE DETECTOR
815 LOOP FILTER
1000 LOS-MIMO RADIO COMMUNICATION SYSTEM

What is claimed is:

1. (canceled)

2. A modulation apparatus used in a line of sight multiple input multiple output (LOS-MIMO: Line Of Sight-Multiple Input Multiple Output) radio communication system, comprising:
means for generating a spread code of a sequence length of a time-domain pilot signal sequence and generating a second number of cyclic shift sequences by cyclically shifting the generated spread code;
means for transforming the second number of pilot signals into a third number of frequency-domain signals corresponding to the sequence length;
means for mapping the third number of frequency-domain signals onto a fifth number of frequency components at a fourth number of subcarrier intervals by shifting mapping positions of heads of the frequency-domain signals one after another by an amount equivalent to one subcarrier so that the frequency-domain signals do not overlap each other, the fourth number being a number based on the number of transmitting antennas of the modulation apparatus and the second number, and the fifth number being a number based on the sequence length and the fourth number;
means for transforming the mapped frequency-domain signals into time-domain signals; and
means for setting the time-domain signals in a pilot block.

3. The modulation apparatus according to claim 2, further comprising:
means for receiving a message for controlling transmission power of the pilot signal from a demodulation apparatus according to whether or not an error rate measured by the demodulation apparatus meets a target error rate; and
means for controlling the transmission power according to the message.

4-5. (canceled)

6. A demodulation apparatus used in a line of sight multiple input multiple output (LOS-MIMO: Line Of Sight-Multiple Input Multiple Output) radio communication system, comprising:
means for estimating, by using a pilot signal contained in a reception signal, a first channel response of a transmission signal transmitted from each of a plurality of transmitting antennas provided in another radio communication apparatus;
means for estimating, based on the estimated first channel response, a phase variation at a pilot block position at which the pilot signal is set;
means for, based on the phase variation at the pilot block position, interpolating and compensating for the phase variation at a block position at which an information symbol included between adjacent pilot block positions is set;
means for transforming the reception signal which has been compensated for the phase variation into a frequency-domain signal;
means for estimating, by using the pilot signal contained in the frequency-domain signal, a second channel response indicating a channel response, at each of a plurality of subcarrier positions, to a transmission signal transmitted from each of the plurality of transmission antennas;
means for generating an equalization weight based on the estimated second channel response, and equalizing the frequency-domain signal by multiplying an information symbol at each of the plurality of subcarrier positions by the equalization weight; and
means for transforming the equalized frequency-domain signal into a time-domain signal.

7. A demodulation apparatus used in a line of sight multiple input multiple output (LOS-MIMO: Line Of Sight-Multiple Input Multiple Output) radio communication system, comprising:
means for transforming a time-domain reception signal into a frequency-domain signal;
means for estimating, by using a pilot signal contained in the transformed frequency-domain signal, a channel response, at each of a plurality of subcarrier positions, to a transmission signal transmitted from each of a plurality of transmission antennas provided in another radio communication apparatus;
means for estimating, based on the estimated channel response, a common phase variation common to all the subcarrier positions, and compensating for the estimated common phase variation from the transformed frequency-domain signal;
means for generating an equalization weight based on the estimated channel response, and equalizing the frequency-domain signal by multiplying an information symbol at each of the plurality of subcarrier positions at which the common phase variation has been compensated for by the equalization weight; and
means for transforming the equalized frequency-domain signal into a time-domain signal.

8. The demodulation apparatus according to claim 7, further comprising means for estimating inter-subcarrier interference at each of the plurality of subcarrier positions, and compensating for the estimated inter-subcarrier interference.

9. The demodulation apparatus according to claim 8, further comprising means for equalizing the frequency-domain signal which has been compensated for the inter-subcarrier interference by multiplying the frequency-domain signal which has been compensated for the inter-subcarrier interference by the equalization weight, wherein
the compensation means estimates inter-subcarrier interference at each of the plurality of subcarrier positions based on the frequency-domain signal at each of the plurality of subcarrier positions, the estimated channel response, and the multiplied frequency-domain signal at each of the plurality of subcarrier positions, and compensates the estimated inter-subcarrier interference, and
the means for transformation transforms the frequency-domain signal which has been obtained by equalizing the frequency-domain signal which has been compensated for the inter-subcarrier interference into a time-domain signal.

10. The demodulation apparatus according to claim 8, wherein the means for compensation estimates inter-subcarrier interference at each of the plurality of subcarrier positions based on the frequency-domain signal at each of the plurality of subcarrier positions, the estimated channel response, the multiplied frequency-domain signal at each of the plurality of subcarrier positions, and a decision feedback information symbol, and compensates for the estimated inter-subcarrier interference.

11. The demodulation apparatus according to claim 10, further comprising:
means for making a hard decision on the transformed time-domain signal and outputs the decision feedback information symbol; and
means for transforming the decision feedback information symbol into one in the frequency domain.

12. The demodulation apparatus according to claim 10, further comprising:
means for calculating a log likelihood ratio of each bit of an information symbol contained in the transformed time-domain signal;
an error-correcting decoder configured to perform error-correcting decoding on the log likelihood ratio;
means for estimating a transmission bit by making a hard decision on the error-correcting decoded log likelihood ratio;
means for generating the decision feedback information symbol by error-correcting encoding an estimated value of the transmission bit; and
means for transforming the decision feedback information symbol into one in the frequency domain.

13. The demodulation apparatus according to claim 6, further comprising means for estimating a residual phase variation contained in the transformed time-domain signal, and reducing the estimated residual phase variation from the transformed time-domain signal.

14. The demodulation apparatus according to claim 7, further comprising means for estimating a residual phase variation contained in the transformed time-domain signal, and reducing the estimated residual phase variation from the transformed time-domain signal.
